(19) United States
(12) Patent Application Publication
(10) Pub. No.: US 2026/0006074 A1
(43) Pub. Date: Jan. 1, 2026

(54) PROACTIVELY DISCOVERING MALICIOUS DOMAINS THROUGH GUIDED CRAWLING OF ATTACK INFRASTRUCTURE

(71) Applicant: Palo Alto Networks, Inc., Santa Clara, CA (US)

(72) Inventors: Mohamed Yoosuf Mohamed Nabeel, San Jose, CA (US); Keerthiraj Nagaraj, Santa Clara, CA (US); Shehroze Farooqi, Sunnyvale, CA (US); William Russell Melicher, Sunnyvale, CA (US); Oleksii Starov, Sunnyvale, CA (US)

(21) Appl. No.: 18/758,234

(22) Filed: Jun. 28, 2024

(51) Int. Cl. H04L 9/40; G06F 16/951

(52) U.S. Cl. CPC H04L 63/1483; H04L 63/1425; G06F 16/951

(57) ABSTRACT

The present application discloses a method, system, and computer system for proactively discovering malicious domains through a guided crawling of attack infrastructure. The method includes (i) determining a set of toxic network neighborhoods on the internet, (ii) expanding one or more network graphs for the set of toxic network neighborhoods; (iii) determining a set of domains expected to be malicious from the set of toxic network neighborhoods, and (iv) performing an action based at least in part on the set of domains expected to be malicious. A particular toxic network neighborhood shares a plurality of hosting environments.

### BACKGROUND OF THE INVENTION

The proliferation of internet-based services and applications has resulted in an unprecedented growth of domain registrations. While many of these domains are utilized for legitimate purposes, a significant number are created with malicious intent, posing substantial security risks to users and organizations. Cybercriminals often exploit newly registered domains to launch phishing attacks, distribute malware, orchestrate botnet activities, and execute other malicious operations. Consequently, detecting and mitigating threats from such domains has become a critical concern in cybersecurity.

### BRIEF DESCRIPTION OF THE DRAWINGS

Various embodiments of the invention are disclosed in the following detailed description and the accompanying drawings.

FIG. 1 is a block diagram of an environment for performing proactive guided discovery of suspicious domains to be classified according to various embodiments.

FIG. 2 is a block diagram of a system to detect suspicious domains to be classified for deployment of active measures with respect to the classifications according to various embodiments.

FIG. 3 is a flow diagram of a method for performing guided discovery of new suspicious domains to be classified according to various embodiments.

FIG. 4 is an illustration of a network neighborhood according to various embodiments.

FIG. 5 is an illustration of example associations with a set of seed domains to explore via expansion of resources according to various embodiments.

FIG. 6 is an illustration of an example of an expansion of resources based on a set of seed domains according to various embodiments.

FIG. 7 is an illustration of a system for discovering a set of suspicious domains according to various embodiments.

FIG. 8 is a flow diagram of a method for discovering a set of domains that are expected to be malicious according to various embodiments.

FIG. 9 is a flow diagram of a method for identifying a set of seed domains or seed IP addresses according to various embodiments.

FIG. 10 is a flow diagram of a method for discovering network resources based on a set of seed domains or seed IP addresses according to various embodiments.

FIG. 11 is a flow diagram of a method for identifying a set of likely malicious domains based on a seed list of malicious domains or IP addresses according to various embodiments.

FIG. 12 is a flow diagram of a method for determining a set of network neighborhoods according to various embodiments.

FIG. 13 is a flow diagram of a method for determining a toxicity for a network neighborhood according to various embodiments.

FIG. 14 is a flow diagram of a method for identifying a set of suspicious domains according to various embodiments.

FIG. 15 is a flow diagram of a method for classifying a candidate domain according to various embodiments.

FIG. 16 is a flow diagram of a method for training a model according to various embodiments.

FIG. 17 is a flow diagram of a method for detecting malicious traffic according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a security entity may include a network node (e.g., a device) that enforces one or more security policies with respect to information such as network traffic, files, etc. As an example, a security entity may be a firewall. As another example, a security entity may be implemented as a router, a switch, a DNS resolver, a computer, a tablet, a laptop, a smartphone, etc. Various other devices may be implemented as a security entity. As another example, a security may be implemented as an application running on a device, such as an anti-malware application.

Traditional security mechanisms, such as firewalls and intrusion detection systems (IDS), typically rely on known threat signatures and heuristics to identify and block malicious domains. However, these approaches are reactive, often failing to detect newly registered or identified domains that have not yet exhibited malicious behavior or been included in threat intelligence databases. This lag in detection can leave systems vulnerable during the critical window when these newly registered or identified domains are most dangerous.

Recent advances have focused on more proactive strategies, such as domain reputation scoring and machine learning-based analysis, to identify potentially malicious domains at the point of registration or shortly thereafter. These methods analyze various features, including domain age, registrar information, domain name structure, and hosting infrastructure, to assess the likelihood of a domain being malicious. Despite their promise, existing solutions often lack the precision and speed necessary for real-time threat mitigation, leading to either over-blocking legitimate domains or under-detecting malicious ones.

Although there are many excellent malicious domain detectors, the coverage of detection and proactiveness of detection by such detectors is low. With contemporary attack durations reducing from days to hours, enterprises generally require early detection of malicious domains involved in order to protect the enterprise and its users. A key reason for the low coverage and proactiveness is that the existing detectors do not “see” many malicious domains because they mostly take a reactive approach to detection. Various embodiments propose a novel proactive approach to increase the coverage and proactiveness of detection of malicious domains by performing guided smart crawling of attack infrastructure.

A naive approach to increasing the coverage and proactiveness of detection is to analyze all domains observed through a passive DNS service. However, such an approach is computationally very inefficient and does not scale as the number of domains observed per day approaches or exceeds the billions of domains observed per day and correspondingly, the toxicity (e.g., the proportion of malicious domains compared to the benign domains, or a proportion of malicious domains to total domains) is extremely low. Cybercriminals have been observed to often share, reuse, and/or rotate their attack infrastructure as well as to register domains and/or certificates in bulk through automation. Various embodiments use this observation to identify toxic network neighborhoods on the Internet. Many of these neighborhoods use shared hosting environments where hundreds and thousands of benign domains are also hosted.

Various embodiments implement a machine learning based approach to expand the network graph and discover likely malicious domains from these hosting environments, thereby improving the toxicity of the crawled domains and significantly reducing the number of domains to be processed (e.g., classified such as by querying a classifier using machine learning model).

Various embodiments utilize unsupervised machine learning to narrow the likely malicious domains. The newly discovered likely malicious domains are then fed to a content based detectors (e.g., one or more machine learning models that generate a prediction of whether a domain is malicious or a likelihood that a domain is malicious) to detect malicious domains.

Empirical studies and simulation show that over 500 new malicious domains (e.g., about 10% addition to the related art detections approaches) are discovered proactively through implementation of various embodiments.

Various embodiments address these challenges by providing a novel method for discovering and pre-classifying potentially malicious domains before any traffic to or from these domains reaches a firewall. This proactive approach integrates advanced data analytics and machine learning techniques to evaluate and score newly registered domains based on a comprehensive set of features. By pre-classifying domains, the system enables firewalls to intercept traffic associated with high-risk domains more effectively, thereby enhancing the overall security posture and reducing the likelihood of successful cyberattacks.

Various embodiments provide a method, system, and computer system for proactively discovering malicious domains through a guided crawling of attack infrastructure. The method includes (i) determining a set of toxic network neighborhoods on the internet, (ii) expanding one or more network graphs for the set of toxic network neighborhoods; (iii) determining a set of domains expected to be malicious from the set of toxic network neighborhoods, and (iv) performing an action based at least in part on the set of domains expected to be malicious. A particular toxic network neighborhood shares a plurality of hosting environments.

According to various embodiments, the system determines a set of seed malicious domains and/or IP addresses. The system then expands these set of seed malicious nodes (e.g., the network graphs for the seed domains) based on various associations (e.g., based on a determination that domains share a particular network resource), and then prunes and clusters the collection of seed domains and newly discovered domains to identify likely malicious domains. In some embodiments, the system uses a comprehensive list of associations to expand the initial seed list. The system can perform guided discovery of the new domains based at least in part on a machine learning (ML) technique. For example, the guided expansion algorithm according to various embodiments is powered by a lightweight ML model. In response to determining an expanded network for domains (e.g., the collection of seed domains and malicious domains, the system prunes the expanded network (e.g., the expanded graph) to reduce noise, such as to remove likely unrelated or highly benign domains. The system performs a network-based clustering of the graph to identify toxic sub-neighborhoods in the graph (e.g., neighborhoods having a toxicity that exceeds a predefined toxicity threshold, such as neighborhoods having a greater proportion of seed domains). In response to determining toxic network neighborhoods, the system classifies the domains (e.g., the newly discovered domains) within the toxic network neighborhoods. For example, the system uses a classification pipeline to predict/determine whether the newly discovered domains within toxic network neighborhoods are malicious (or a likelihood that the domains are malicious).

According to various embodiments, a security entity and/or network node (e.g., a client, device, etc.) handles a file based at least in part on an indication that the file is malicious and/or that the file matches a file indicated to be malicious. In response to receiving indication that the file (e.g., the sample is malicious), the security network and/or network node may update a mapping of files to an indication of whether the corresponding file is malicious, and/or a blacklist of files. In some embodiments, the security entity and/or the network node receives a signature pertaining to a file (e.g., a sample deemed to be malicious), and the security entity and/or the network node stores the signature of the file for use in connection with detecting whether files obtained, such as via network traffic, are malicious (e.g., based at least in part on comparing a signature generated for the file with a signature for a file comprised in a blacklist of files). As an example, the signature may be a hash. In some embodiments, the signature for the file is the Unmanaged Imphash corresponding to such file.

Various embodiments advance cybersecurity, offering a robust solution for preemptively identifying and mitigating threats from newly registered and potentially malicious domains in an efficient manner to accommodate resource constraints. By integrating with existing firewall infrastructure, various embodiments provide a seamless and efficient means of enhancing network security, protecting users and organizations from a wide array of cyber threats.

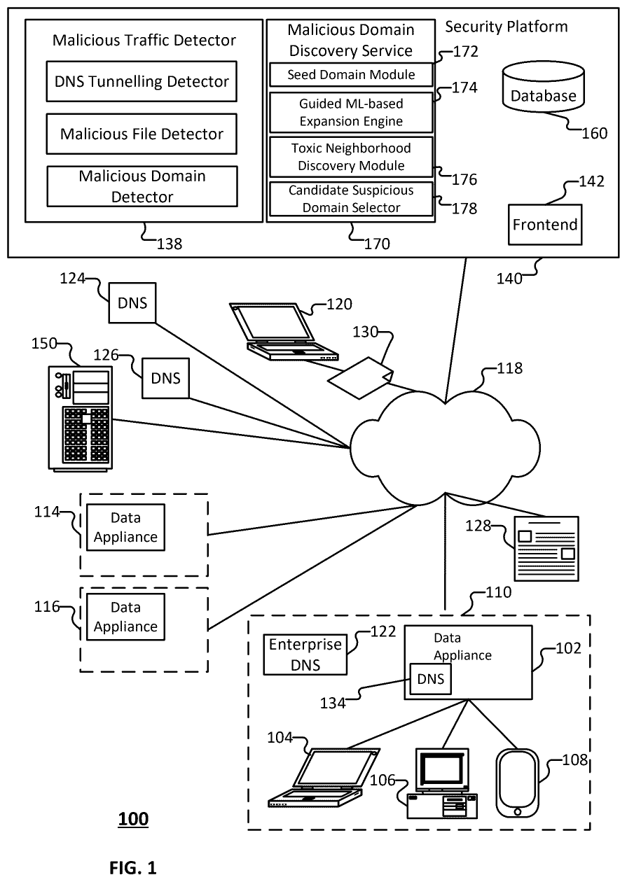

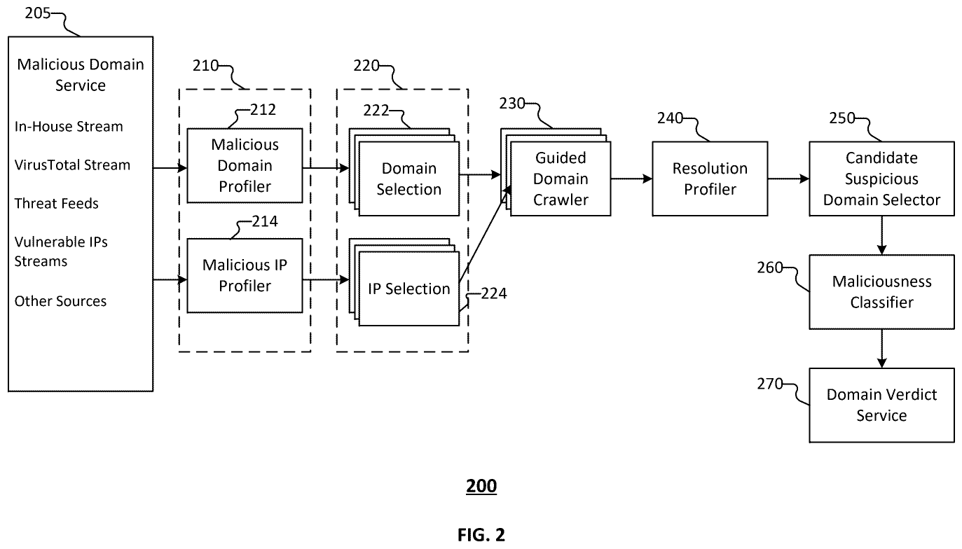

FIG. 1 is a block diagram of an environment for performing proactive guided discovery of suspicious domains to be classified according to various embodiments. In some embodiments, system 100 implements at least in part of system 200 of FIG. 2. System 100 can implement at least part of one or more of processes 300 and 700-1700.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains, DNS hijacked domains, or stockpiled domains, or such as traffic for certain applications (e.g., SaaS applications). In some embodiments, data appliance 102 is also configured to enforce policies with respect to traffic that stays within (or from coming into) enterprise network 110.

In some embodiments, data appliance 102 is a security entity, such as a firewall (e.g., an application firewall, a next generation firewall, etc.). An enterprise network (e.g., a network for a tenant serviced by security platform 140) may comprise a set of data appliances 102 (e.g., a set of remote network nodes).

Firewalls typically deny or permit network transmission based on a set of rules. These sets of rules are often referred to as policies (e.g., network policies, network security policies, security policies, etc.). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies.

Security devices (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QoS), workload balancing of network related resources, and/or other networking functions), and/or other functions. For example, routing functions can be based on source information (e.g., IP address and port), destination information (e.g., IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content (e.g., next generation firewalls). In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content—not just ports, IP addresses, and packets—using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provide higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' VM Series firewalls, which support various commercial virtualized environments, including, for example, VMware® ESXi™ and NSX™ Citrix® Netscaler SDX™, KVM/OpenStack (Centos/RHEL, Ubuntu®), and Amazon Web Services (AWS)). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

Techniques described herein can be used in conjunction with a variety of platforms (e.g., desktops, mobile devices, gaming platforms, embedded systems, etc.) and/or a variety of types of applications (e.g., Android .apk files, iOS applications, Windows PE files, Adobe Acrobat PDF files, Microsoft Windows PE installers, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including securing code within a codebase (e.g., a code repository), automatically injecting an SDK into certain code snippets (e.g., code samples) for the codebase, or various other security services for network traffic, such as real-time or contemporaneous classifications, or offline classifications. The various other security services may include classifying domains (e.g., predicting whether a domain is a DNS hijacked domain, etc.), classifying network traffic, providing a mapping of signatures to certain domains (e.g., domains for which a predicted likelihood that the domain is a DNS hijacked domain exceeds a predefined likelihood threshold, etc. a mapping of domains to domain data (e.g., domain certificates, pDNS data, active DNS data, WHOIS data, etc.), performing static and dynamic analysis on malware samples, monitoring new domains (e.g., detecting new domains for which a certificate is issued/generated), assessing maliciousness of domains, determining whether a domain associated with a traffic sample is (or is likely to be) a DNS hijacked domain, providing a list of signatures of known exploits (e.g., malicious input strings, malicious files, malicious domains, etc.) to data appliances, such as data appliance 102 as part of a subscription, detecting exploits such as malicious input strings, malicious files, or malicious domains (e.g., an on-demand detection, or periodical-based updates to a mapping of domains to indications of whether the domains are malicious or benign), providing a likelihood that a domain is malicious (e.g., a parked domain, a DNS hijacked domain) or benign (e.g., an unparked domain), providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, or domains are malicious, providing an indication that an input string, file, or domain is malicious (or benign), simulating DNS hijacking attacks/campaigns (e.g., generating synthetic DNS hijacking records), and training classifiers (e.g., training machine learning models, such as to be used to provide inline detection of DNS hijacked domains, or offline detection of DNS hijacked domains).

In some embodiments, security platform 140 is deployed as a cloud service. For example, security platform 140 may be implemented by one or more servers and may comprise one or more clusters of worker nodes (e.g., virtual machines).

In some embodiments, security platform 140 classifies the network traffic, files, or domains in response to receiving a network traffic sample or according to a predefined schedule. For example, security platform 140 can perform the classification as the endpoint or network entity (e.g., a firewall or data appliance 102) detects traffic for a new domain, traffic to/from a suspicious domain, a new file, etc. In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

In the example shown, security platform 140 comprises malicious traffic detector 138. Malicious traffic detector can classify network traffic in real-time (e.g., contemporaneous with a firewall, such as data appliance 102 receiving such traffic) or offline (e.g., to generate whitelists or blacklists, etc.). As illustrated, malicious traffic detector 138 can comprise a DNS tunneling detector, a malicious file detector, or a malicious domain detector (e.g., to predict whether a domain is malicious or hijacked, etc.). Malicious traffic detector 138 may implement one or more classifiers, such as machine learning models, to predict the classifications. Additionally, malicious traffic detector 138 may train the machine learning model(s) to perform the classifications. According to various embodiments, security platform 140 may perform various other security services.

Security platform 140 comprises malicious domain discovery service 170. Malicious domain discovery service 170 can identify suspicious domains (e.g., domains for which traffic has not yet been intercepted or classified), such as through a guided domain discovery process. As shown, malicious domain discovery service 170 can comprise seed domain module 172, guided ML-based expansion engine 174, toxic neighborhood discovery module 176, and candidate suspicious domain selector 178.

Malicious domain discovery service 170 uses seed domain module 172 to determine a set of seed domains and/or seed IPs to be used in connection with the domain discovery. Seed domain module 172 receives data indicating that one or more domains are known malicious domains. The data may be received from malicious traffic detector 138, database 160, security platform 140, a security entity or elsewhere in system 100. Additionally, or alternatively, the data may be received from a third party service such as VirusTotal, etc. In response to receiving the data indicating the malicious domains and IP addresses, seed domain module 172 selects a set of seed malicious domains and/or IP addresses based at least in part on the set of known malicious domains or malicious IP addresses. For example, malicious domain discovery service 170 may use a classifier (e.g., a machine learning model) to predict a maliciousness for the known malicious domains and/or malicious IP addresses. The malicious may be a score that indicates a badness of the domain/IP or a likelihood that the domain/IP is malicious.

Malicious domain discovery service 170 uses guided ML-based expansion engine 174 to perform domain discovery based at least in part on the set of seed malicious domains and/or seed malicious IP addresses. The guided ML-based expansion engine 174 can crawl the network graph defined by the set of seed malicious domains and/or seed malicious IP addresses and determine whether to expand each node in the graph based on a prediction of whether the expansion is likely to result in additional suspicious domains or whether the expansion will dilute the toxicity of the network (e.g., by discovering more likely benign domains). The guided ML-based expansion engine 174 can evaluate whether to expand the graph from a node along a particular dimension based on querying a machine learning model, a set of predefined rules, and/or a set of predefined heuristics.

In response to performing the guided ML-based expansion, toxic neighborhood discovery module 176 can identify a set of toxic neighborhoods of domains within the network. For example, toxic neighborhood discovery module 176 performs a clustering with respect to the network (e.g., a clustering of the seed domains, the newly discovered domains, and the relationships among the domains) to determine a set of network neighborhoods. Toxic neighborhood discovery module 176 can then identify a subset of the set of network neighborhoods as a set of toxic neighborhoods. Toxic neighborhood discovery module 176 determines the toxicity of the set of network neighborhoods and determines that those network neighborhoods having a toxicity greater than a predefined toxicity threshold are toxic network neighborhoods. The toxicity for a network neighborhood can be determined based at least in part on a number of known malicious domains (e.g., seed malicious domains) within the network neighborhood.

In response to determining the set of toxic network neighborhoods, candidate suspicious domain selector 178 selects the suspicious domains to be proactively classified, such as by querying malicious traffic detector 138 or another classification system or service. Candidate suspicious domain selector 178 identifies those newly discovered domains within the set of toxic network neighborhoods as suspicious domains.

Security platform 140 causes the suspicious domains to be proactively classified (e.g., before traffic to/from the suspicious domains is intercepted by a network security entity) by malicious traffic detector or another service. In response to obtaining the domain classifications, security platform 140 can proactively update whitelists or blacklists, as applicable, to comprise the domain classifications.

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjgfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In various embodiments, when a client device (e.g., client device 104) attempts to resolve an SQL statement or SQL command, or other command injection string, data appliance 102 uses the corresponding domain (e.g., an input string) as a query to security platform 140. This query can be performed concurrently with the resolution of the SQL statement, SQL command, or other command injection string. As one example, data appliance 102 can send a query (e.g., in the JSON format) to a frontend 142 of security platform 140 via a REST API. Using processing described in more detail below, security platform 140 will determine whether the queried SQL statement, SQL command, or other command injection string indicates an exploit attempt and provide a result back to data appliance 102 (e.g., “malicious exploit” or “benign traffic”).

In various embodiments, when a client device (e.g., client device 104) attempts to open a file or input string that was received, such as via an attachment to an email, instant message, or otherwise exchanged via a network, or when a client device receives such a file or input string, DNS module 134 uses the file or input string (or a computed hash or signature, or other unique identifier, etc.) as a query to security platform 140. In other implementations, an inline security entity queries a mapping of hashes/signatures to traffic classifications (e.g., indications that the traffic is C2 traffic, indications that the traffic is malicious traffic, indications that the traffic is benign/non-malicious, etc.). This query can be performed contemporaneously with receipt of the file or input string, or in response to a request from a user to scan the file. As one example, data appliance 102 can send a query (e.g., in the JSON format) to a frontend 142 of security platform 140 via a REST API. Using processing described in more detail below, security platform 140 will determine (e.g., using a malicious file detector that may use a machine learning model to detect/predict whether the file is malicious) whether the queried file is a malicious file (or likely to be a malicious file) and provide a result back to data appliance 102 (e.g., “malicious file” or “benign file”).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

FIG. 2 is a block diagram of a system to detect suspicious domains to be classified for deployment of active measures with respect to the classifications according to various embodiments. In some embodiments, system 200 implements at least part of system 100 of FIG. 1. In some embodiments, system 200 implements one or more of processes 300 and 700-1700.

In the example shown, system 200 comprises malicious domain service 205, profiling service 210, resource selection service 220, guided domain crawling service 230, resolution profiler 240, and candidate suspicious domain selection service 250. System 200 may additionally include a maliciousness classification service 260, and a domain verdict service 270. Alternatively, the maliciousness classification service 260 and/or the domain verdict service 270 may be implemented by another system, such as by a third party service, etc.

System 200 uses malicious domain service 205 to obtain a set of known malicious domains and/or a set of known malicious IP addresses. Malicious domain service 205 obtains the malicious domains/IP addresses based on information from one or more other input streams. The input streams may provide various information for malicious classifications that can be associated with a domain. For example, the input streams may include an indication of malicious domains, malicious URLs, malicious IPs, malware (e.g., a SHA256 associated with a maliciousness classification), etc. Examples of the input streams include (a) an in-house stream (e.g., a stream of detected malicious domains, such as in connection with performing classifications for traffic intercepted across a network); (b) a VirusTotal stream (e.g., a stream of indications of domains that are deemed malicious according to VirusTotal or that have a VirusTotal score that exceeds a predefined threshold); (c) threat feeds, (d) vulnerable IP streams, (e) other sources such as other third party services that provide information pertaining to malicious domains/IP addresses.

System 200 uses profile service 210 to determine profiles for the domains or IPs determined based on the stream/feed data received by malicious domain service 205. The profiles can be used to select a seed of malicious domains and/or malicious IP addresses to be used in connection with a guided discovery of new domains (e.g., domains that have some relation or association with the seed domains and that may be more likely to be malicious). In the example shown, profile service 210 comprises malicious domain profiler 212 to profile domains received from malicious domain service 205, and malicious IP profiler 214 to profile IP addresses received from malicious domain service 205.

The malicious domain profiler 212 obtains an indication of a set of malicious domains (e.g., from malicious domain service 205) and determines a profile for the set of malicious domains. Malicious domain profiler 212 can build a database to profile domains based at least in part on the streams of data obtained from malicious domain service 205. The information used for a profile includes one or more of: (a) a first seen time, (b) a last seen time, (c) a number of times the resource is observed (e.g., observed across the various data streams received by malicious domain service 205), (d) a source from which the domain has been received (an in-house classifications feed, VirusTotal, etc.), (e) a number of malicious URLs observed, and (f) a number of benign URLs observed. Various other information may be obtained for the domains. The information used to populate the profile may be obtained by one or more services, including in-house detection services or third party services, etc. System 200 can use the domain profiles in connection with identifying recently observed malicious domains for the seed(s) of the guided domain discovery.

The malicious IP profiler 214 obtains an indication of a set of malicious IPs (e.g., from malicious domain service 205) and determines a profile for the set of malicious IPs. Malicious IP profiler 214 can build a database to profile IPs based at least in part on the streams of data obtained from malicious domain service 205. The information used for a profile includes one or more of: (a) a first seen time, (b) a last seen time, (c) a first seen time for a malicious domain (e.g., a domain classified as malicious by an in-house classification/security service, or a third party service), (d) a last seen time for a malicious domain, (e) a number of domains hosted at the IP, (f) a number malicious domains hosted at the IP, and (f) a source from which the IP has been received (an in-house classifications feed, VirusTotal, etc.). Various other information may be obtained for the IPs. The first seen time for malicious domains may refer to a time at which the IP was first observed in connection with a malicious domain. The information used to populate the profile may be obtained by one or more services, including in-house detection services or third party services, etc. System 200 can use the domain profiles in connection with identifying recently observed malicious domains for the seed(s) of the guided domain discovery.

In response to profiling the set of malicious domains and/or malicious IPs (e.g., the domains and IPs identified in the data streams obtained from malicious domain service 205), system 200 uses resource selection service 220 to select the domains and/or IPs for which the guided discovery is to expand their sub-graphs (e.g., the network graphs for those domains/IPs). The selected domains and/or IP addresses can be used as seed malicious domains or seed malicious IPs for the guided domain discovery. In the example shown, resource selection service 220 comprises a domain selection service 222 for selecting and an IP selection service 224.

The domain selection service 222 selects the seed malicious domains from among the set of malicious domains received from malicious domain service 205. As an example, the domain selection service 222 classifies the set of malicious domains and selects the seed malicious domains based on the classification. In some embodiments, domain selection service 222 implements a machine learning model to predict a score such as a maliciousness score or a reputational score, etc. with which to prioritize the domains among the set of malicious domains for selection of the seed malicious domains. The score may be an indication of a likelihood that a particular domain is malicious, an extent to which the domain is malicious, etc. Domain selection service 222 may limit its classification and/or selection of domains to only those domains that were seen within a predefined period of time (e.g., within the last 7 days, etc.). Malicious domains seen less recently than the predefined period of time may be deemed stale and not likely to provide a high density of suspicious domains (e.g., domains expected to be malicious) within their expanded network graph.

In some embodiments, the domain selection service 222 obtains information pertaining to the domains to be classified (e.g., for which a score is to be predicted) and queries a machine learning model based on such information. For example, the domain selection service 222 may extract a set of features based on the obtained information pertaining to the domain. Examples of features that can be implemented by the machine learning model are provided in Table 1 below. However, additional or other features may be implemented.

In some embodiments, the machine learning model is a Random Forest Classifier. System 200 classifies the set of malicious domains and ranks the malicious domains observed within the last predefined number of days (e.g., a configurable threshold) by the classification confidence score. The top N malicious domains are selected as the seed malicious domains for the guided domain discovery. N can be a configurable positive integer. As an illustrative example, N can be in the range of 1000s.

TABLE 1

| Feature Name | Description |
|---|---|
| Time since last detected | The duration between now and the last |
| | detected time. |
| Domain age | The duration between now and a domain |
| | creation time (e.g., as specified in the |
| | corresponding WHOIS record). |
| Reputable Registrar | An indication of whether the registered |
| | domain is reputable. For example, an |
| | indication that the registered domain has a |
| | reputation (e.g., determined by a third party |
| | service, etc.) that exceeds a reputation |
| | threshold. |
| Passive DNS Duration | The duration between first seen and last seen |
| | timestamps in a passive DNS. |
| Passive DNS Query | The number of times the domain is queried as |
| Count | recorded in passive DNS. |
| Customer Domain | The popularity of the domain for the customer |
| Popularity | traffic (e.g., a localized domain popularity, |
| | such as determined by a number of times the |
| | domain is accessed for a tenant or enterprise |
| | network. The greater the number, the more |
| | popular the domain is deemed). |
| Global Domain | The global popularity of the domain as |
| Popularity | measured by a third party service, such as the |
| | Tranco top domain list. |
| Time since last scanned | The duration between now and the time the |
| | domain was last scanned. |
| Number of times scanned | The number of times the domain has been |
| | scanned previously. In some embodiments, |
| | the number of times scanned is the number of |
| | scans within a predetermined period of time |
| | (e.g., the number of times scanned in the last |
| | 7 days, 30 days, etc.). |
| VT positive count | Number of VirusTotal scanners that mark the |
| | domain as malicious. |

The IP selection service 224 selects the seed malicious IPs from among the set of malicious IPs received from malicious domain service 205. As an example, the IP selection service 224 classifies the set of malicious IPs and selects the seed malicious IPs (or associated domains) based on the classification. In some embodiments, IP selection service 224 implements a machine learning model to predict a score such as a maliciousness score or a reputational score, etc. with which to prioritize the IPs among the set of malicious IPs for selection of the seed malicious IPs. The score may be an indication of a likelihood that a particular IP is malicious (or hosts a malicious domain), an extent to which the IP is malicious, etc. IP selection service 224 may limit its classification and/or selection of domains to only those domains that were seen within a predefined period of time (e.g., within the last 7 days, etc.). Malicious IPs seen less recently than the predefined period of time may be deemed stale and not likely to provide a high density of suspicious domains (e.g., domains expected to be malicious) within their expanded network graph.

In some embodiments, the IP selection service 224 obtains information pertaining to the domains to be classified (e.g., for which a score is to be predicted) and queries a machine learning model based on such information. For example, the IP selection service 224 may extract a set of features based on the obtained information pertaining to the IP. Examples of features that can be implemented by the machine learning model are provided in Table 2 below. However, additional or other features may be implemented.

In some embodiments, the machine learning model is a Random Forest Classifier. System 200 classifies the set of malicious IPs and ranks the malicious IPs observed within the last predefined number of days (e.g., a configurable threshold) by the classification confidence score. The top N malicious IPs are selected as the seed malicious IPs for the guided domain discovery. N can be a configurable positive integer. As an illustrative example, N can be in the range of 1000s.

TABLE 2

| Feature Name | Description |
|---|---|
| Time since the last | The duration from now to the last malicious |
| malicious domain observed | domain hosted on the IP address. |
| Malicious domain count | The number of malicious domains hosted on |
| | the IP in the last 7 days. |
| VT positive count | The number of VT scanners marked the IP as |
| | malicious. |
| Domain count | The number of domains hosted in the last 30 |
| | days. |
| Time since last scanned | The duration between now and the time the |
| | IP was last scanned. |
| Number of times scanned | The number of times the IP has been scanned |
| | previously. In some embodiments, the |
| | number of times scanned is the number of |
| | scans within a predetermined period of time |
| | (e.g., the number of times scanned in the last |
| | 7 days, 30 days, etc.). |
| Is the IP a hosting IP? | An indication of whether the IP address is a |
| | hosting IP. |

In response to the seed malicious domains and/or seed malicious IPs being determined, system 200 performs a guided domain discovery to identify other domains that, based on their associations with the seed malicious domains or seed malicious IPs, are suspicious domains (e.g., expected to be malicious or more likely to be malicious).

System 200 uses guided domain crawling service 230 to perform the guided domain discovery based at least in part on the seed malicious domains and/or seed malicious IPs. Starting from the seed list of malicious domains and IPs, guided domain crawling service 230 identifies likely malicious domains in the neighborhood leveraging the relationships provided in Table 3.

Guided domain crawling service 230 intelligently explores the sub-graphs for a seed malicious domain or a seed malicious IP by determining whether to expand the network graph along a particular dimension(s), such as based on the relationships provided in Table 3. For example, based on one or more of the relationships provided in Table 3, guided domain crawling service 230 performs a depth-first search to expand the sub-graphs for the seed malicious domains and seed malicious IPs.

Guided domain crawling service 230 can determine whether to expand the network graph for a particular domain along a particular dimension or to another level in that dimension based on a classification/prediction provided by a machine learning model, a set of predefined rules, or a set of predefined heuristics. As an example, guided domain crawling service 230 expands the sub-graph one level (e.g., to identify a direct relationship) for a malicious seed domain along a particular dimension. At each point of guided crawling, guided domain crawling service 230 can check to see if the sub-graph should be expanded or not. For each node/level beyond the node for the seed malicious domain or seed malicious IPs, guided domain crawling service 230 evaluates whether to continue to expand the sub-graph along that dimension based on the machine learning model, the predefined set of rules, or the predefined set of heuristics.

Additionally, guided domain crawling service 230 can determine how far, or an extent to which, the sub-graph is to be expanded. For example, if the node is an IP address that serves as a hosting IP address, expanding to obtain information for all domains hosted at the IP address may be inefficient and decrease or dilute the toxicity of the network. Accordingly, guided domain crawling service 230 can narrow or filter down the domains for which the guided discovery is to be performed. An example of a criteria used to filter domains for which additional information is not to be obtained or for which the sub-graph is not to be expanded can be a time at which the domain was hosted at the particular IP address. System 200 may define limits to identify only those most recently hosted domains (e.g., domains hosted within a predefined threshold period of time) because domains that have been hosted for an extended period of time are unlikely to be malicious (e.g., malicious exploits are typically discovered fairly quickly and removed).

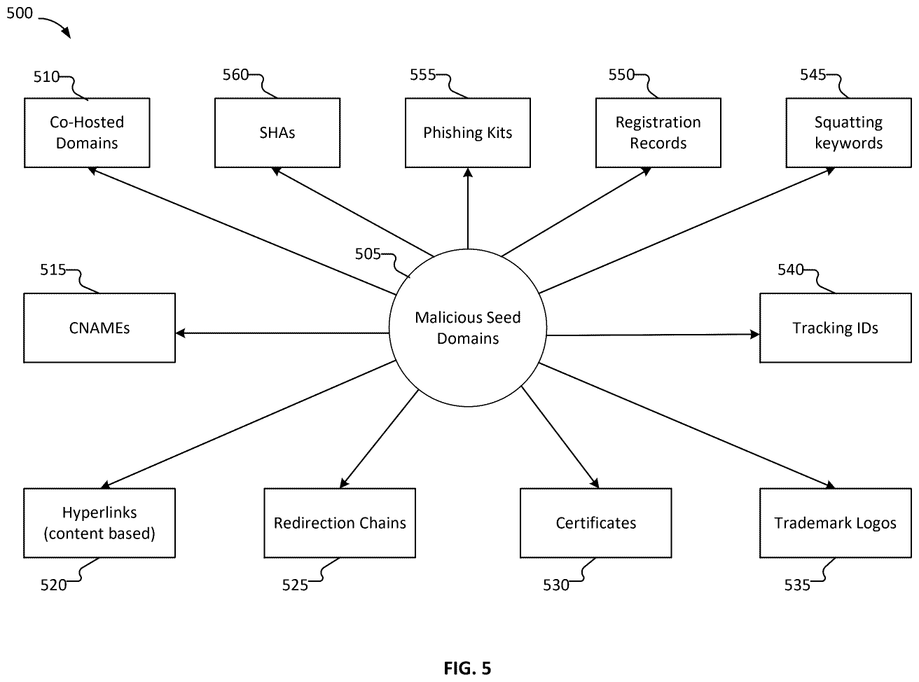

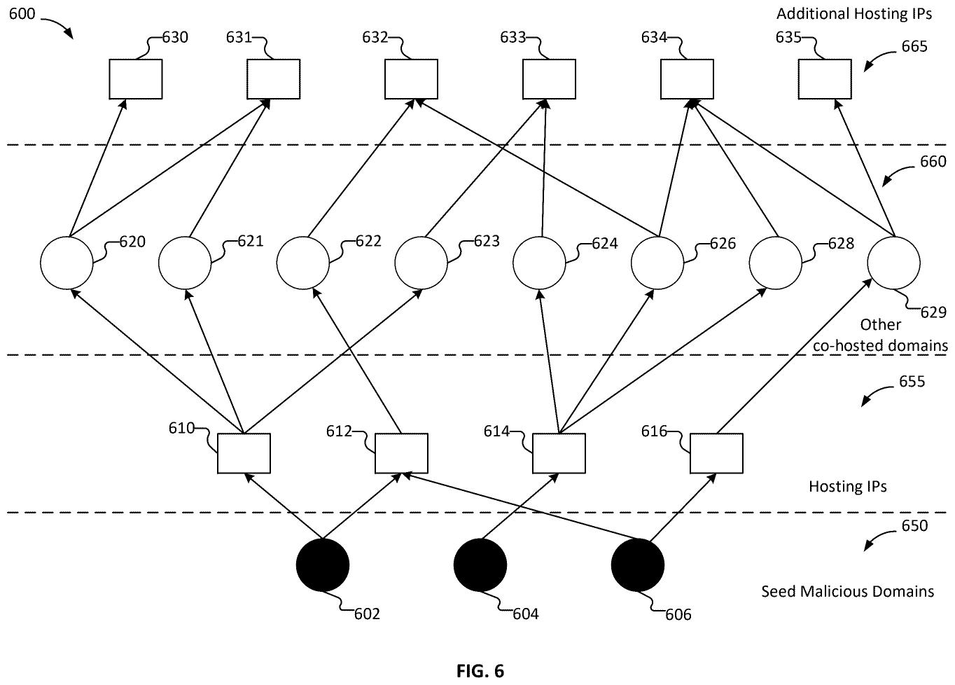

Additional description regarding the guided domain discovery through expanding sub-graphs for domains or IPs is further provided in connection with FIGS. 5 and 6.

TABLE 3

| Relationship | Detailed Relationships |
|---|---|
| Domain-IP | Domain is hosted on the IP |
| Domain-Domain | Domain alias to Domain (e.g., CNAME) |
| | Domain MX Domain |
| | Domain NS Domain |
| | Domain TXT Domain (e.g., SPC domain) |
| | Domain sub-domains Domain |
| Domain-Certificate | Domain is issued the Certificate |
| Domain-Keyword | Domain comprises the keyword |
| Domain-URL | The URL's hostname is Domain |
| IP-Subnet/24 | The IP belongs to Subnet/24 |
| URL-URL | URL directs to URL |
| | URL embeds URL (e.g., hyperlinks in the |
| | context of the URL) |
| | URL contacts URL |
| URL-SHA256 | URL downloads SHA256 |
| | SHA256 contacts URL |
| URL-Tracking IDs | The URL uses the Tracking ID |
| URL-Phishing Kits | The URL is built from the particular |
| | Phishing Kit |
| IP-SHA256 | The IP hosts SHA256 |
| IP-Certificate | The IP is issued the particular Certificate |

In response to performing the guided domain discovery (e.g., crawling the network graph defined based at least in part on the malicious domains or malicious IPs), system 200 uses resolution profiler 240 to profile the relationships between resources/nodes and to identify newly observed relationships. In some embodiments, resolution profiler 240 characterizes a relationship based on (a) a first seen time, (b) a last seen time, and (c) a number of times the resource has been observed. Resolution profiler 240 may be further used to filter or narrow down the newly discovered domains from which suspicious domains are to be selected (e.g., for classification). For example, resolution profiler 240 may pass to candidate suspicious domain selection service 250 only those relationships that were observed within the last predefined number of days (e.g., 14 days or another number that can be configured by an administrator).

System 200 uses candidate suspicious domain selection service 250 to identify suspicious domains (e.g., domains expected to be malicious) from among the domains identified during the guided domain discovery. Suspicious domain selection service 250 can determine weighted domain-to-domain relationships from the expanded network graph identified during the guided domain discovery. In some embodiments, suspicious domain selection service 250 converts the heterogeneous graph into a homogeneous weighted domain graph. The weight of an edge is proportional to the number of edges between two domains in the heterogeneous graph.

In response to determining weighted domain-to-domain relationships, suspicious domain selection service 250 performs a clustering of the domains (e.g., the seed malicious domains/IPs and the newly discovered domains) to identify strongly connected components in the relationships. For example, suspicious domain selection service 250 implements a network-based clustering to determine clusters or groupings of domains (e.g., network neighborhoods). Suspicious domain selection service 250 uses these identified groupings (e.g., network neighborhoods) to identify a set of toxic network neighborhoods. For example, the system identifies those network neighborhoods that are toxic based at least in part on determining a toxicity for the network neighborhoods. A network neighborhood may be deemed a toxic network neighborhood based at least in part on a number of known malicious domains (e.g., seed malicious domains) comprised in the network neighborhood. For example, network neighborhood may be deemed a toxic network neighborhood if the toxicity for the network neighborhood exceeds a predefined toxicity threshold (e.g., if the particular network neighborhood has greater than N seed malicious domains, where N is a configurable predefined threshold).

Suspicious domain selection service 250 deems the newly discovered domains within the set of toxic network neighborhoods to be suspicious domains, or domains that are expected (or relatively likely) to be malicious. For example, Suspicious domain selection service 250 deems the newly discovered domains as the candidate domains that are to be passed to a classification pipeline.

System 200 uses resolution profiler 240 and suspicious domain selection service 250 to determine relationships identified based on the guided discovery performed by guided domain crawling service 230, creating a weighted domain graph, identifying strongly connected components, selecting toxic components, and determining the corresponding suspicious domains.

In response to determining toxic network neighborhoods, system 200 can pass the suspicious domains (e.g., the newly discovered domains within the toxic network neighborhoods) to maliciousness classification service 260 to perform a maliciousness classification or otherwise predict whether the suspicious domains are malicious. Maliciousness classification service 260 can implement one or more classifiers, which may include rule-based classifiers and/or machine learning-based classifiers. Maliciousness classification service 260 can crawl the content of the candidate domains (e.g., the suspicious domains) and perform a static and dynamic analysis to return a verdict of whether a particular suspicious domain is malicious or a likelihood that the particular suspicious domain is malicious.

System 200 uses domain verdict service 270 to implement one or more active measures in response to determining whether a suspicious domain is malicious. Domain verdict service 270 may implement a mapping of indications of whether a domain is malicious to a corresponding active measure. For example, if a particular domain is deemed to be benign, domain verdict service 270 may update a whitelist of benign domains, such as by storing an indication that a hash or other identifier associated with the domain is mapped to a benign domain. Additionally, domain verdict service 270 may push the whitelist to security entities to implement in connection with handling traffic in-line. As another example, if a particular domain is deemed to be malicious, domain verdict service 270 may update a blacklist of malicious domains, such as by storing an indication that a hash or other identifier associated with the domain is mapped to a malicious domain. Additionally, domain verdict service 270 may push the blacklist to security entities to implement in connection with handling traffic in-line.

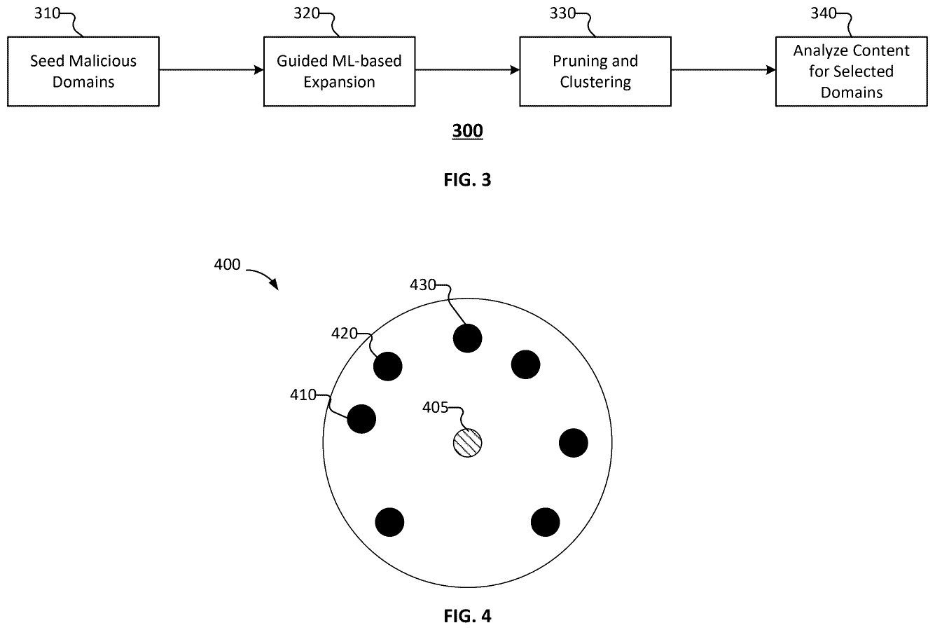

FIG. 3 is a flow diagram of a method for performing guided discovery of new suspicious domains to be classified according to various embodiments. In some embodiments, process 300 is implemented at least in part by system 100 of FIG. 1 and/or system 200 of FIG. 2. Process 300 may be implemented by an upstream device such as a worker node, a virtual machine, etc.

At 310, the system obtains a set of seed malicious domains and/or IP addresses. The system can determine the set of seed malicious domains and/or IP addresses based at least in part on obtaining an indication of a set of known malicious from an in-house detection service and/or one or more third party services, such as a VirusTotal stream/feed, a threat feed, a vulnerable IPs, etc.

At 320, the system performs a guided machine learning-based expansion of a network (e.g., a set of network resources, including IP addresses, domains, etc.). According to various embodiments, the system performs domain discovery based at least in part on identifying other domains that may be related to a seed domain (or seed IP address). The system may identify the other domains by exploring (e.g., expanding) the sub-graph along one or more dimensions for associations that are deemed to be strong (e.g., domains strongly associated with one another through a particular resource).

In some embodiments, the system determines a set of dimensions along which the sub-graph for a particular domain is to be expanded to discover other (e.g., new) domains sharing a characteristic with the particular domain such as a particular network infrastructure resource. The dimensions of the sub-graph can include one or more of the network infrastructure resources. Examples of network infrastructure resources that may be implemented include Examples of network infrastructure resources that may be shared among domains include one or more of co-hosted domains, CNAMEs, hyperlinks (e.g., hyperlinks comprised on a website hosted at the domain(s)), redirection chains, certificates, trademark logos, tracking identifiers, squatting keywords, registration records, phishing kits to deploy malware, and SHAs.

At 330, the system performs a pruning and clustering of the collection of seed domains and newly discovered domains to identify likely malicious domains.

In response to determining an expanded network for domains (e.g., the collection of seed domains and malicious domains, the system prunes the expanded network (e.g., the expanded graph) to reduce noise, such as to remove likely unrelated or highly benign domains. The pruning may implement a prediction engine to identify domains that are expected to be unrelated or benign. The prediction engine may implement a machine learning model to predict domains that are expected to be unrelated or benign, a set of one or more predefined rules, and/or a set of one or more heuristics.

The system clusters the set of seed domains and newly discovered domains (e.g., the domains discovered through the guided ML-based expansion of the network graph comprising the seed domains). For example, the system can implement one or more clustering techniques to identify domain groupings or network neighborhoods. In some embodiments, the system implements a network-based clustering (e.g., to detect communities/neighborhoods among the domains). Various other clustering techniques may be implemented. Examples of other clustering techniques include K-means clustering, hierarchical clustering, DBSCAN clustering, spectral clustering, affinity propagation, Gaussian mixture models (GMM), and self-organizing maps (SOMs).

The system determines a set of groupings (e.g., network neighborhoods or communities) of domains based on the clustering. In response to determining the set of groupings, the system determines a subset of groupings that are toxic. For example, the system identifies those network neighborhoods that are toxic based at least in part on determining a toxicity for the network neighborhoods. A network neighborhood may be deemed a toxic network neighborhood based at least in part on a number of known malicious domains. For example, network neighborhood may be deemed a toxic network neighborhood if the toxicity for the network neighborhood exceeds a predefined toxicity threshold.

In some embodiments, the toxicity for a network neighborhood is determined based at least in part on a number of known malicious domains (e.g., domains within the seed list of malicious domains or malicious IP addresses) in relation to a total number of domains within the network neighborhood.

In some embodiments, the toxicity for a network neighborhood is determined based at least in part on a number of known malicious domains (e.g., domains within the seed list of malicious domains or malicious IP addresses) in relation to a number of benign domains or in relation to unclassified domains.

In response to determining toxic network neighborhoods, the system identifies domains to be classified, for example, to predict whether the domains are malicious or a likelihood that the domains are malicious. For example, the system selects the domains (e.g., the newly discovered domains) within the toxic network neighborhoods for classification. Because seed domains were known malicious domains or known malicious IP address, the system does need to further classify the domains.

At 340, in response to determining toxic network neighborhoods, the system classifies the domains (e.g., the newly discovered domains) within the toxic network neighborhoods. For example, the system uses a classification pipeline to predict/determine whether the newly discovered domains within toxic network neighborhoods are malicious (or a likelihood that the domains are malicious).

The system can query a prediction engine or other service (e.g., a classification service) to determine a classification (e.g., a maliciousness classification) for the newly discovered domain. In response to obtaining/determining the classification, the system can perform an active measure based on the classification. The system can update a blacklist of malicious domains to comprise those newly discovered domains for which a classification is malicious, such as mapping a hash or other identifier for a domain to an indication that the domain is malicious. Additionally, or alternatively, the system can update a whitelist of benign domains to comprise those newly discovered domains for which a classification is benign/non-malicious, such as mapping a hash or other identifier for a domain to an indication that the domain is benign/non-malicious. Various other active measures can be implemented, such as providing an alert to a user (e.g., an administrator) or other system/service.

FIG. 4 is an illustration of a network neighborhood according to various embodiments. In some embodiments, the system performs a clustering of the set of seed malicious domains/IP addresses and newly discovered domains to identify likely malicious domains. For example, the system performs a clustering to identify a set of network neighborhoods respectively comprising a set of domains, which include at least one seed domain and one or more other domains (e.g., another seed domain(s) or newly discovered domain(s).

In the example shown, network neighborhood 400 comprises seed domain 405 and a set of other domains, including domain 410, domain 420, and domain 430. The network neighborhood 400 comprises a set of domains that are closely related or exhibit similar characteristics.

In some embodiments, in response to determining a network neighborhood, the system can determine an associated toxicity, which can be used to determine whether to provide the set of domains in the network neighborhood (e.g., the newly discovered domains). The toxicity may be determined based on Equation (1) below.

$$Toxicity = \frac{( number of seed domains in the network neighborhood )}{( total number of domains in the network neighborhood )} \qquad ( 1 )$$

FIG. 5 is an illustration of example associations with a set of seed domains to explore via expansion of resources according to various embodiments. According to various embodiments, the system performs domain discovery based at least in part on identifying other domains that may be related to a seed domain (or seed IP address). The system may identify the other domains by exploring (e.g., expanding) the sub-graph along one or more dimensions for associations that are deemed to be strong (e.g., domains strongly associated with one another through a particular resource).

In the example shown, system 500 deems two domains to be strongly associated if they are related via one or more of the network resources. Examples of the network resources through which domains may be related (e.g., strongly associated) include: (a) a hosting IP address, (b) a Conical Name (CNAME) record (e.g., alias associations), (c) one or more hyperlinks comprised on the website content, (d) a redirection chain, (e) a certificate associated with a particular domain, (f) a trademark logo used on the content hosted at the domain, (g) a tracking identifier associated with the domain, (h) one or more squatting keywords used in the domain, (i) a registration record associated with the domain, ( ) a phishing kit used to generate a webpage, and (k) SHAs hosted at the domains (e.g., hashes for files, such as malware, hosted at the domain).

In the example shown, system 500 obtains a set of malicious seed domains 505. In connection with performing discovery for new domains that are potentially malicious, system 500 expands the sub-graphs for a particular seed domain (e.g., each seed domain). The system can determine to expand the sub-graphs to a next level or to a level after a first expansion based at least in part on a machine learning model (e.g., a maliciousness score or reputation proxy generated by a machine learning model) or a predefined set of rules or heuristics.

System 500 can expand the sub-graphs for malicious seed domains 505 to identify a set of co-hosted domains 510. For example, system 500 identifies the domains hosted at a same hosting IP as a particular seed domain in the malicious seed domains 505.

System 500 can expand the sub-graphs for malicious seed domains 505 to identify domains having a same CNAME 515. For example, system 500 identifies domains having aliases associations.

System 500 can expand the sub-graphs for malicious seed domains 505 to identify domains having a same hyperlink comprised in the content hosted at the domains. For example, system 500 identifies a set of hyperlinks 520 comprised in content hosted at the domain and determines the hyperlinks within the set of hyperlinks for which the sub-graphs are to be expanded. System 500 can prioritize hyperlinks for which the sub-graph is to be expanded.

System 500 may store a database or mapping of redirection websites. System 500 can expand the sub-graphs for malicious seed domains 505 to identify any redirection chains 525 associated with a particular malicious seed domain.

Each domain generally has a certificate. For example, more and more web browsers do not accept webpages that do not use the HTTPS protocol and thus the domain needs a certificate. System 500 uses certificate information (e.g., a certificate report) to identify the certificates 530 related to the domain (e.g., a malicious seed domain) and identifies other domains using the same certificates 530. In some embodiments, the system disregards (e.g., determines not to expand a sub-graph for) certificates having a number of associated domains greater than a predefined threshold. For example, if a certificate has more than ten associated domains, the system determines not to expand sub-graph for the domain along the certificate dimension.

System 500 can expand the sub-graphs for malicious seed domains 505 to identify domains having a same trademark logos comprised in the content hosted at the domains. For example, system 500 identifies a set of trademarks 535 (e.g., logos) comprised in content hosted at the domain and determines the trademarks for which the sub-graph is to be expanded to identify other domains for which hosted content comprise the same trademark(s).

System 500 can expand the sub-graphs for malicious seed domains 505 to identify domains having same associated tracking identifiers 540. For example, different attackers use different types of tracking identifiers (e.g., from Google or other sites). The attackers (or domain owners) use the tracking identifiers to track the performance of the website. For example, the attackers use the tracking identifiers to track the success of an attack. System 500 identifies a set of domains having a same or similar tracking identifier as another domain (e.g., a domain from which a sub-graph is to be expanded, such as a malicious seed domain).

System 500 can expand the sub-graphs for malicious seed domains 505 to identify domains having the same associated squatting keywords 545. Malicious attackers register and use squatting domains that impersonate popular domains. System can identify keywords used in the squatting domains to identify related domains (e.g., domains using the keywords).

System 500 can expand the sub-graphs for malicious seed domains 505 to identify domains having the related registration records 550. System 500 can identify related registration records based on one or more characteristics associated with the registration records. For example, the system identifies records registered within a predefined time interval. Malicious attackers often register domains to be used for malicious purposes in bulk. Accordingly, temporally close registration creation times can be indicative of related domains. In some embodiments, the system identifies related domains through the registration record dimension based on finding domains having a same or related registrar and/or close creation times.

System 500 can expand the sub-graphs for malicious seed domains 505 to identify domains having the related phishing kits 555. Malicious webpages are generally generated using a phishing kit. System 500 can use an association between a domain and a phishing kit (e.g., a phishing kit used to create the content hosted at the domain) to discover related domains, such as other domains that are associated with the phishing kit.

System 500 can expand the sub-graphs for malicious seed domains 505 to identify domains having related SHAs 560 (e.g., a SHA 456). Domains can host various content or files, which can be hashed to determine the corresponding SHA (e.g., downloading, comm, referrer, etc.). System 500 can use an association between a domain and SHA to discover related domains, such as other domains that host content or files having a same SHA (e.g., a same hash).

FIG. 6 is an illustration of an example of an expansion of resources based on a set of seed domains according to various embodiments. In the example shown, a sub-graph 600 has been expanded in connection with discovering related domains. Sub-graph 600 comprises a first level 650 comprising a set of seed domains 602-606; a second level 655 comprising hosting IPs 610-616; a third level 660 comprising other co-hosted domains 620-629; and fourth level 665 comprising additional hosting IPs 630-635.

In response to determining the seed domains 602-606 (or seed IP addresses), the system determines to expand the sub-graphs for the seed domains 602-606 along the dimension (e.g., network infrastructure resource) hosting IPs, for example, to identify the hosting IPs associated with each of seed domains 602-606. The system can begin to map the relationships between the seed domains and the second level 655 of hosting IPs. In some embodiments, the system determines the hosting IPs for the second level 655 by identifying the recent hosting IPs for the seed domains (e.g., hosting IPs that hosted the seed domain within predefined period of time, such as the last N days, where N is a configurable positive integer such as 14). Old hosting information for seed domains are generally stale and do not yield currently active toxic neighborhoods.

In response to determining the hosting IPs (e.g., the recent hosting IPs) for the seed domains, the system expands the sub-graph 600 one level further along the dimension of hosting IPs to discover other domains hosted at the same hosting IPs (e.g., the hosting IPs 610-616 at the second level 655) as seed domains 602-604. Although a plurality of seed domains can be co-hosted by a same hosting IP, the sub-graph extending from such hosting IP only needs to be profiled or expanded once to explore the sub-graph and discover new domains. As illustrated, the system discovers the other domains 620-629 to be hosted at the same hosting IPs. In some embodiments, the system deems only those domains newly hosted (e.g., hosted within predefined period of time, such as the last M days, where M is a configurable positive integer such as 14) by the hosting IPs 610-616 to be discovered domains. For example, the system again discards stale records because exploration of stale records is generally unlikely to reveal other active malicious domains.

In some embodiments, the system can implement an informed decision making process in connection with determining whether to further expand the sub-graph, such as to expand the sub-graphs from newly discovered domains 620-629 to identify other hosting IPs for the newly discovered domains 620-629 (e.g., hosting IPs that are not identified in the second level 655). The informed decision making process may include querying a classifier, such as a machine learning model (e.g., a lightweight machine learning model), or using one or more predefined rules.

In some embodiments, the system uses a prediction engine to determine whether to expand the sub-graph to another level or for the specific resources (e.g., domains, hosting IPs, etc.) for which to expand the sub-graph. The prediction engine may implement a machine learning model or a predefined set of rules or heuristics. As an illustrative example, in the case of the system using a machine learning model in connection with determining whether to expand a particular resource to another level (e.g., to identify other hosting IPs associated with a particular domain in the current level), the machine learning model can generate a maliciousness score or other proxy for the reputation of the particular domain being evaluated.

Expanding the sub-graph to a next level generates an exponential growth of the sub-domain, which can lead to a reduction in the toxicity of network neighborhoods. In some embodiments, the system constrains the number of levels or number of that are to be expanded for the guided domain discovery, or the number of records that are to be expanded for the guided discovery. As an example, the system may be constrained/configured to expand a total of three levels (e.g., along any particular dimension).

In some implementations, one or more of processes 700-1700 may be implemented by one or more servers, such as in connection with providing a service to a network or a tenant. For example, processes 700-1700 are implemented by one or more servers that provide a security platform (e.g., a cloud service) such as to provide code security (e.g., to secure against code vulnerabilities for cloud-to-cloud services/communications), traffic classifications, malicious file or traffic detections, etc. In some implementations, one or more of processes 700-1700 may be implemented by a security entity (e.g., a firewall) such as in connection with enforcing a security policy with respect to traffic from/to domains across a network or in/out of the network.

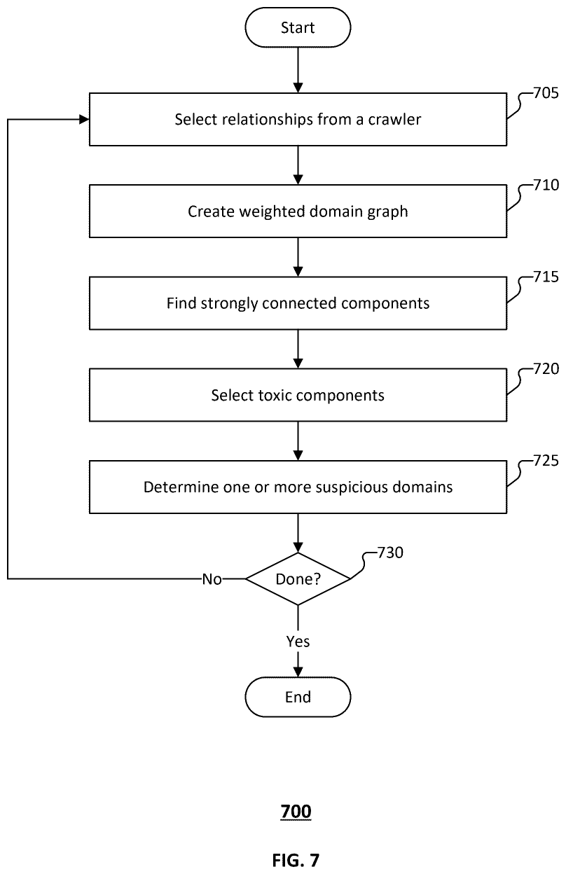

FIG. 7 is an illustration of a system for discovering a set of suspicious domains according to various embodiments. In some embodiments, process 700 is implemented at least in part by system 100 of FIG. 1 and/or system 200 of FIG. 2. Process 700 may be implemented by an upstream device such as a worker node, a virtual machine, etc.

In some embodiments, process 700 is invoked by a system or service that is configured to perform discovery of domains for which a maliciousness classification is to be obtained. For example, process 700 is invoked to perform a proactive discovery of suspicious domains before network traffic to/from such domains is intercepted by a security service. The proactive discovery of suspicious domains enables a security service to determine whether the domain is benign or malicious before network traffic to/from the domain emerges.

At 705, the system selects relationships from a crawler. The crawler may be configured to crawl certain domains or IP addresses from a set of known malicious domains or IP addresses. Such domains or IP addresses are crawled to discover other domains through various relationships. Examples of resources through which relationships may be discovered include (a) a hosting IP address, (b) a TLS certificate, (c) an implemented phishing kit, (d) a registration record, (e) a CNAME record, (f) one or more hyperlinks comprised in a website, (g) malware files hosted at a domain, (h) a redirection chain, (i) a set of keywords, (j) a tracking identifier, and (k) a logo hosted comprised in the website. However, various other resources may be implemented.

The system (e.g., the crawler) has identified (e.g., via a guided domain discovery) a set of domains that are related to certain seed malicious domains or malicious IP addresses either directly or indirectly through one or more resources. As an example, the system discovers that a first domain has a same hosting IP address as a second domain. As another example, the system discovers that a third domain uses the same TLS certificate as a fourth domain which hosts a website comprising one or more hyperlinks that are displayed on a website for a fifth domain. In this example, the third domain is indirectly associated with the fifth domain, such as via the fourth domain through two different types of resources.

At 710, the system creates a weighted domain graph. In connection with determining network neighborhood, the system collapses the relationships between domains into a weighted domain-to-domain relationship. In some embodiments, the weight of an edge in the weighted domain graph is proportional to the number of edges between domains in a heterogeneous graph (e.g., the number of resources via which any two domains are related/connected).

According to various embodiments, using the examples above, the relationship between the first domain and the second domain via the hosting IP address is represented as a direct relationship between the first domain and the second domain with a corresponding weighting (e.g., a first weighting). Similarly, the relationship between the third domain and the fifth domain is represented as a direct relationship between the third domain and the fifth domain with a corresponding weighting (e.g., a second weighting). From these examples, the first weighting may be greater than the second weighting because the first domain and the second domain are more closely associated.

According to various embodiments, the system weights the relationship between any two domains based on the number of resources via which the two domains are associated. For example, if a first domain and second domain have the same hosting IP address, TLS certificate, and registration record, the system may more heavily weight the relationship between the first domain and the second domain than in the case that the first domain and second domain only had the same TLS certificate.

At 715, the system finds strongly connected components. In some embodiments, the system performs clustering based at least in part on the weighted domain graph to identify the strongly connected components. The connected components can correspond to network neighborhoods comprising a neighborhood of domains that are strongly connected.

At 720, the system selects toxic components. The system analyzes the strongly connected components and determines those components that are toxic. For example, the system determines a toxicity of each strongly connected component, and deems those strongly connected components having a toxicity greater than a predefined toxicity threshold as toxic. In the case of the components being network neighborhoods (e.g., neighborhoods of domains), the system determines that a particular network neighborhood is toxic based on a determination that the toxicity for the particular network neighborhood is greater than a predefined toxicity threshold.

In some embodiments, the toxicity for a network neighborhood is determined based at least in part on a number of known malicious domains (e.g., domains within the seed list of malicious domains or malicious IP addresses) in relation to a total number of domains within the network neighborhood. As an illustrative example, if a first network neighborhood comprises 10 domains and 4 of those domains were domains corresponding to domains or IP addresses from the seed list, then the first network neighborhood is deemed to have a toxicity of 0.4 (e.g., 4 known malicious domains divided by 10 total domains). Conversely, if a second network neighborhood has 8 total domains and only 2 of those domains were corresponding to domains or IP addresses from the seed list, then the second network neighborhood is deemed to have a toxicity of 0.25, which is less toxic than the first network neighborhood

At 725, the system determines one or more suspicious domains. In some embodiments, the system determines the domains within the toxic components, for example, the domains within a toxic network neighborhood and deems such domains as suspicious domains. The system may deem only those unknown domains within the toxic network neighborhood as being suspicious, for example, because the domains corresponding to malicious domains or IP addresses from the seed list are known to be malicious.

The system can use the one or more suspicious domains to proactively perform a domain classification. For example, the system queries a classifier to predict whether the suspicious domains are benign or malicious. The classification of the suspicious domains may be performed before a security service has intercepted traffic to/from the suspicious domains. The system can use the classifications to update whitelists or blacklists of domains or to otherwise determine how to handle traffic to/from the suspicious domains when the security service (e.g., a firewall) intercepts traffic to/from the suspicious domains. Additionally, or alternatively, the system can provide an alert corresponding to classification of the suspicious domains. For example, the system may alert a network administrator of a suspicious domain that is predicted to be malicious. As another example, the system may communicate an indication that a particular suspicious domain is predicted to be malicious, such as in connection with providing a stream of malicious domains.

At 730, a determination is made as to whether process 700 is complete. In some embodiments, process 700 is determined to be complete in response to a determination that no further suspicious domains are to be discovered, no further seed malicious domains or malicious IP addresses are to be evaluated (e.g., explored or expanded to find associated/related domains), an administrator indicates that process 700 is to be paused or stopped, etc. In response to a determination that process 700 is complete, process 700 ends. In response to a determination that process 700 is not complete, process 700 returns to 705.

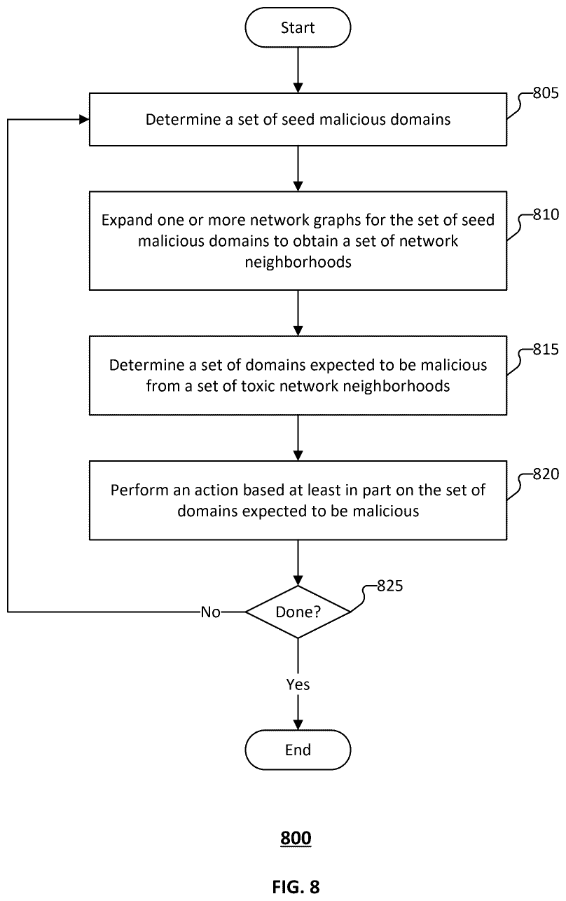

FIG. 8 is a flow diagram of a method for discovering a set of domains that are expected to be malicious according to various embodiments. In some embodiments, process 800 is implemented at least in part by system 100 of FIG. 1 and/or system 200 of FIG. 2. Process 800 may be implemented by an upstream device such as a worker node, a virtual machine, etc.

Although the example shown is described in the context of using malicious domains as seed malicious domains, the same or similar process can be implemented for the use of seed malicious IP addresses. As another example, the use of the term seed malicious domains may include domains obtained from a set of known malicious domains (e.g., received through a malicious domain streaming service, such as malicious domain service 205) domains associated with a set of known malicious IP addresses (e.g., received through the malicious domain streaming service).

At 805, the system determines a set of seed malicious domains. For example, the system obtains from one or more sources an indication of known malicious domains and/or known malicious IP addresses. The system determines a set of seed malicious domains from the set of known malicious domains and/or known malicious IP addresses. In some embodiments, the system selects the set of seed malicious domains based on a classification of the domains associated with the set of known malicious domains and/or known malicious IP addresses, for example, a predicted maliciousness of such domains. The system may query a machine learning model, such as a lightweight model, to predict the maliciousness of the domains based on one or more characteristics of the domains.

At 810, the system expands one or more network graphs for the set of seed malicious domains to obtain a set of network neighborhoods. The system takes the seed malicious domains and identifies/discovers other domains using the same infrastructure (e.g., hosting IP address, TLS certificates, domain registrations, distributing the same malware, comprising a same set of hyperlinks, etc.). The system can generate an expanded network graph for the domains.

At 815, the system determines a set of domains expected to be malicious from a set of toxic network neighborhoods. In some embodiments, the system processes the one or more expanded network graphs to identify a set of network neighborhoods (e.g., a domain neighborhood comprising strongly connected domains). In response to determining the set of network neighborhoods, the system identifies a set of toxic network neighborhoods from the set of network neighborhoods. A network neighborhood is deemed to be toxic if its corresponding toxicity is greater than a predefined toxicity threshold. The toxicity for a particular network neighborhood can be determined based on a number of known malicious domains (e.g., a number of seed malicious domains) relative to (e.g., divided by) the number of total domains within the particular network neighborhood.

The set of domains expected to be malicious may be suspicious domains for which the system obtains (e.g., determines or queries a classifier) a maliciousness classification, for example, to obtain an indication of whether the domain is benign or malicious. The set of domains expected to be malicious correspond to the newly discovered domains within the set of toxic network neighborhoods (e.g., all the domains within the set of toxic network neighborhoods excluding those domains that were on the seed list of malicious domains and/or malicious IP addresses).

At 820, the system performs an action based at least in part on the set of domains expected to be malicious. In some embodiments, the system obtains a set of malicious classifications for the set of domains expected to be malicious (e.g., the suspicious domains). For example, the system queries a classifier for a predicted classification of whether a suspicious domain is benign or malicious. The system can use the classifications (e.g., the predicted classifications) in connection with updating a whitelist of benign domains or a blacklist of malicious domains, as applicable. Additionally, or alternatively, the system can handle intercepted traffic to/from a domain based on the predicted classification for the domain, if any (e.g., if the domain was previously intercepted or was otherwise proactively discovered as a suspicious domain and proactively classified). Additionally, or alternatively, the system can provide an alert or prompt to a user (e.g., a system administrator) that certain domains are malicious.

At 825, a determination is made as to whether process 800 is complete. In some embodiments, process 800 is determined to be complete in response to a determination that no further suspicious domains (e.g., domains expected to be malicious) are to be discovered, no further seed malicious domains or malicious IP addresses are to be evaluated (e.g., explored or expanded to find associated/related domains), no further active measures are to be performed with respect to suspicious domains, an administrator indicates that process 800 is to be paused or stopped, etc. In response to a determination that process 800 is complete, process 800 ends. In response to a determination that process 800 is not complete, process 800 returns to 805.

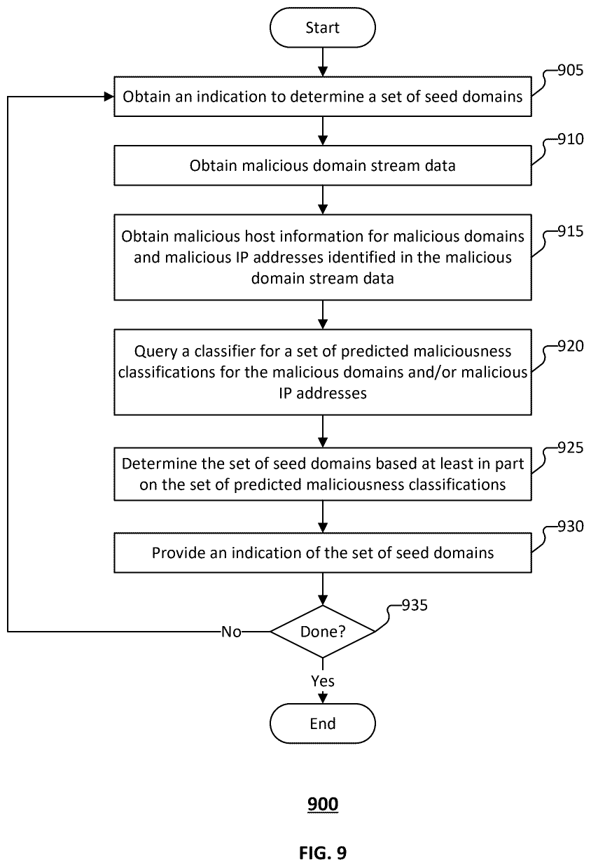

FIG. 9 is a flow diagram of a method for identifying a set of seed domains or seed IP addresses according to various embodiments. In some embodiments, process 900 is implemented at least in part by system 100 of FIG. 1 and/or system 200 of FIG. 2. Process 900 may be implemented by an upstream device such as a worker node, a virtual machine, etc.

Although the example shown is described in the context of using malicious domains as seed malicious domains, the same or similar process can be implemented for the use of seed malicious IP addresses. As another example, the use of the term seed malicious domains may include domains obtained from a set of known malicious domains (e.g., received through a malicious domain streaming service, such as malicious domain service 205) domains associated with a set of known malicious IP addresses (e.g., received through the malicious domain streaming service).

At 905, the system obtains an indication to determine a set of seed domains. At 910, the system obtains malicious stream data. The malicious stream data (e.g., a stream of malicious domains and/or malicious IP addresses) may be received from one or more sources (e.g., third party services or other systems) and may comprise indications of known malicious domains or known malicious IP addresses. At 915, the system obtains malicious host information for malicious domains and malicious IP addresses identified in the malicious domain stream data. For those domains identified in the malicious stream data, the system can profile the domains or IP.

The information used to profile the domains can be included in the malicious stream data, or obtained from a third party service (e.g., a domain registration service) or by crawling a webpage hosted at the domain. Example of information the system can use in determining a domain profile include one or more of: (a) a first seen time, (b) a last seen time, (c) a number of times the resource is observed, (d) a source from which the domain is obtained (e.g., in-house, VirusTotal, threat feeds, etc.), (e) a number of malicious URLs observed (.g., the number of malicious URLs hosted on the webpage), and (f) a number of benign URLs observed (e.g., the number of benign URLs hosted on the webpage).

The information used to profile the IP addresses can be included in the malicious stream data, or obtained from a third party service (e.g., a domain registration service) or by crawling a webpage hosted at the IP address. Example of information the system can use in determining a domain profile include one or more of: (a) a first seen time, (b) a last seen time, (c) a first seen time for a malicious domain associated with the IP address (e.g., based on a domain that is classified as malicious by a classifier or a domain having a VirusTotal score greater than a predefined threshold such as 3, etc.), (d) a last seen time for a malicious domain associated with the IP address (e.g., based on a predicted classification obtained by a classifier, a VirusTotal score, etc.), (e) a number of domains hosted in association with the IP address, (f) a number of malicious domains hosted in association with the IP address, (g) a source from which the IP address is obtained (e.g., in-house, VirusTotal, threat feeds, etc.).

At 920, the system queries a classifier for a set of predicted maliciousness classifications for the malicious domains and/or malicious IP addresses. In response to identifying domains and/or IP addresses that are known to be malicious, the system determines a maliciousness score for the identified domains and IP addresses. For example, the system queries one or more lightweight machine learning models to predict a maliciousness score for the domains and IP addresses. The system may use a first classifier (e.g., a machine learning model) to predict a maliciousness score for domains, and a second classifier (e.g., a machine learning model) to predict a maliciousness score for IP addresses.

In some embodiments, the system uses the maliciousness score to prioritize those domains and/or IP addresses for which related domains are to be discovered by expanding their corresponding networks/sub-graphs. The discovery of related domains comprising identifying domains that share a network infrastructure resource with one of the known malicious domains or IP addresses (e.g., the particular domains/IP addresses that are prioritized for guided discovery). Examples of network infrastructure resources that may be shared among domains include one or more of co-hosted domains, CNAMEs, hyperlinks (e.g., hyperlinks comprised on a website hosted at the domain(s)), redirection chains, certificates, trademark logos, tracking identifiers, squatting keywords, registration records, phishing kits to deploy malware, and SHAs. Various other types of network infrastructure resources may be implemented and used for discovery of related domains.

At 925, the system determines the set of seed domains based at least in part on the set of predicted maliciousness classifications. The system uses the predicted maliciousness classification (e.g., the maliciousness score or predicted measure of an extent to which a domain is malicious, or a predicted likelihood that a domain is malicious, etc.) to identify a set of seed domains. Performing domain discovery using all known malicious domains may not be feasible given finite resources (e.g., time, compute resources, etc.). Thus, the system prioritizes the known malicious domains and IP addresses according to the set of predicted maliciousness classifications to determine a set of seed domains. The system can determine the set of seed domains according to one or more predefined rules. Examples of a rule that can be used to determine the set of seed domains include: (a) the N domains having a highest maliciousness score, where N is a positive integer; (b) the M domains having a highest predicted likelihood to be malicious, where M is a positive integer; (c) all domains having a maliciousness score greater than a predefined maliciousness score; (d) domains that were first seen within a predefined period of time (e.g., within a week, month, etc.); etc. Various other rules can be used to prioritize the malicious domains/IP addresses and to select the seed domains.

At 930, the system provides an indication of the set of seed domains. In some embodiments, the system provides the indication to another process, service, or system that invoked process 900.

At 935, a determination is made as to whether process 900 is complete. In some embodiments, process 900 is determined to be complete in response to a determination that no further suspicious domains (e.g., domains expected to be malicious) are to be discovered, no further seed malicious domains or malicious IP addresses are to be evaluated (e.g., explored or expanded to find associated/related domains), no further active measures are to be performed with respect to suspicious domains, an administrator indicates that process 900 is to be paused or stopped, etc. In response to a determination that process 900 is complete, process 900 ends. In response to a determination that process 900 is not complete, process 900 returns to 905.

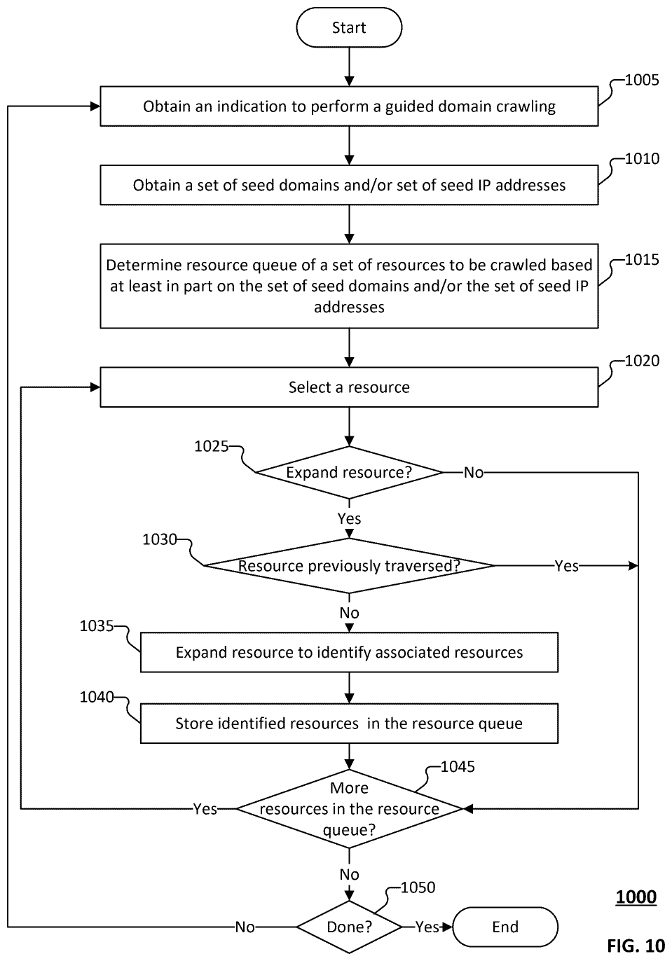

FIG. 10 is a flow diagram of a method for discovering network resources based on a set of seed domains or seed IP addresses according to various embodiments. In some embodiments, process 1000 is implemented at least in part by system 100 of FIG. 1 and/or system 200 of FIG. 2. Process 1000 may be implemented by an upstream device such as a worker node, a virtual machine, etc.

At 1005, the system obtains an indication to perform a guided domain crawling. In some embodiments, the guided domain crawling is performed periodically. For example, the guided domain crawling is performed according to a predefined schedule such as daily, weekly, monthly, etc. Additionally, or alternatively, the guided domain crawling is performed upon request from an administrator or other user. Another system or process can determine to perform the guided domain crawling and provide an indication to process 1000, or otherwise invoke process 1000.

At 1010, the system obtains a set of seed domains and/or set of seed IP addresses. For example, the system obtains the seed domains/IP addresses from process 900 (e.g., at 930).

At 1015, the system determines a resource queue of a set of resources to be crawled based at least in part on the set of seed domains and/or set of seed IP addresses. In some embodiments, the system determines a set of dimensions along which the sub-graph for a particular domain is to be expanded to discover other (e.g., new) domains sharing a characteristic with the particular domain such as a particular network infrastructure resource. The dimensions of the sub-graph can include one or more of the network infrastructure resources. Examples of network infrastructure resources that may be implemented include Examples of network infrastructure resources that may be shared among domains include one or more of co-hosted domains, CNAMEs, hyperlinks (e.g., hyperlinks comprised on a website hosted at the domain(s)), redirection chains, certificates, trademark logos, tracking identifiers, squatting keywords, registration records, phishing kits to deploy malware, and SHAs.

In some embodiments, the system may make an informed determination of whether to expand the sub-graph for a particular domain along a particular dimension. For example, the system obtains the seed domains/IP addresses, determines the hosting IP addresses in the last N days for the seed domains/IP addresses. N may be a configurable number. The system may only consider recent hosting IP addresses as relevant for discovering other related domains because hosting IP addresses from a longer period of time is deemed sale and do not tend to yield currently active toxic network neighborhoods. As an example, N may be 14 so the system identifies those hosting IP addresses used within the last 14 days for each seed domain/IP address. The system uses these hosting IP addresses used within the last N days to identify other newly hosted domains within the last M days. M may be configurable number, which may be the same as N. As an illustrative example, M may be 14. In response to determining the other domains hosted at the hosting IP addresses within the last M days, the system can further determine whether to expand the sub-graphs for those newly discovered domains.

Although the system can iteratively determine whether to expand the sub-graphs for domains discovered in a previous iteration, the exponential nature of the interconnected domains may make scaling beyond a few iterations infeasible. In some embodiments, the system expands the sub-graph for a particular seed domain up to 3 layers (e.g., the system performs two iterations of expanding the sub-graphs for domains discovered by expanding the sub-graph for the particular seed domain).

In some embodiments, the system determines whether to expand the sub-graph/network for a particular domain based at least in part on querying a classifier and/or according to one or more predefined rules. For example, the system can implement a lightweight machine learning model that determines a score for the node (e.g., the domain). The score predicted by the machine learning model can be a proxy for the reputation of the node. Accordingly, if the score predicted by the machine learning model is greater than a predefined threshold, the system determines to expand the sub-graph for that node (e.g., that domain such as to find other domains related to that domain).

According to various embodiments, the system determines whether to expand the sub-graph for a particular domain along the dimension corresponding to co-hosted domains (e.g., expanded based on the hosting IP address for the particular domain) based on querying a classifier (e.g., the machine learning model). The system can determine whether to expand the sub-graph for the particular domain along another dimension (e.g., a dimension that is not based on the hosting IP address for the particular domain) based on one or more predefined rules. Examples of predefined rules includes (a) the domain being expanded is determined to be a subdomain from a rentable domain (e.g., weebly.com); (b) the IP being expanded is a sinkholed IP; and (c) the IP being expanded is a cloud firewall IP. Various other rules or heuristics may be implemented in connection with determining whether to expand the sub-graph.

At 1020, the system selects a resource. The resource can be a seed malicious domain or a seed malicious IP address comprised in the resource queue.

At 1025, the system determines whether to expand the selected resource. For example, the system determines whether to expand the selected resource along one or more dimensions based at least in part on a predicted classification obtained from a classifier (e.g., a predicted score serving as a proxy for the reputation or predicted maliciousness of the selected resource) and one or more predefined rules.

In response to determining not to expand the selected resource, process 1000 proceeds to 1040. Conversely, in response to determining to expand the selected resource, process 1000 proceeds to 1030.

At 1030, the system determines whether the resource has been previously traversed. In response to determining that the resource has been previously traversed, the system does not store the resource in the resource queue for crawling/discovery and instead proceeds to 1045. If the resource has been previously traversed, the system does not add the resource to the resource queue to avoid duplicating efforts in the discovery of new resources (e.g., domains or IP addresses). For example, a resource could have had an association with another seed domain or IP address or other newly discovered resource based on the seed domains/IP addresses, and thus may have been previously discovered through another relationship, etc. Conversely, in response to determining that the resource has not been previously traversed, process 1000 proceeds to 1035. At 1035, the system expands the resource to identify associated resources.

At 1040, the system stores identified resources in the resource queue.

In response to determining that the selected resource had been previously traversed, process 1000 proceeds to 1040. Conversely, in response to determining to expand the selected resource, process 1000 proceeds to 1030.

At 1045, the system determines whether more resources in the resource queue are to be evaluated (e.g., expanded and explored for downstream associated resources). The system may determine that no further resources in the resource queue are to be evaluated in response to determining that all resources in the resource queue have been evaluated or in response to a determination that compute resources available to evaluate further resources are constrained. As an example, the system may determine that the compute resources are constrained in response to determining that a predefined time period has elapsed for resource/sub-graph expansion. As another example, the system may determine that the compute resources are constrained in response to determining that a latency in evaluating/expanding resources is greater than a predefined latency, for example, because all allocated threads or workers are occupied/assigned to evaluating other resources. In response to determining that the resource queue comprises more resources to be evaluated, process 1000 returns to 1020 and process 1000 iterates over 1020-1045 until no further resources in the resource queue are to be evaluated.

At 1050, a determination is made as to whether process 1000 is complete. In some embodiments, process 1000 is determined to be complete in response to a determination that no further domains are to be crawled, no further resources are to be expanded, no further sub-graphs for the seed malicious domains or malicious IP addresses are to be explored/expanded, a predefined time period for performing the guided domain crawling has elapsed, an administrator indicates that process 1000 is to be paused or stopped, etc. In response to a determination that process 1000 is complete, process 1000 ends. In response to a determination that process 1000 is not complete, process 1000 returns to 1005.

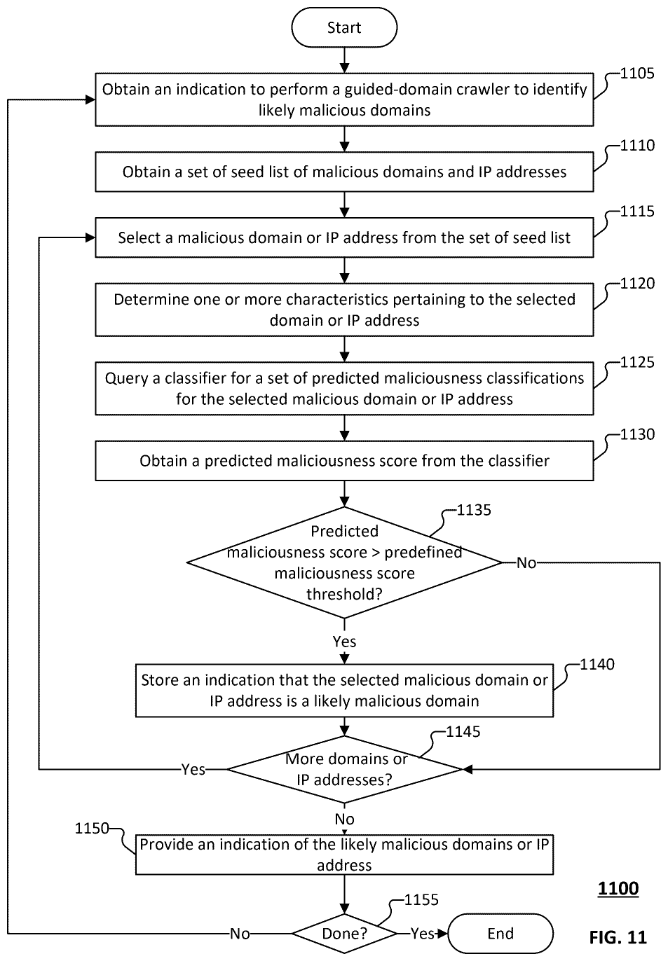

FIG. 11 is a flow diagram of a method for identifying a set of likely malicious domains based on a seed list of malicious domains or IP addresses according to various embodiments. In some embodiments, process 1100 is implemented at least in part by system 100 of FIG. 1 and/or system 200 of FIG. 2. Process 1100 may be implemented by an upstream device such as a worker node, a virtual machine, etc.

In some embodiments, process 1100 is invoked to narrow down (e.g., filter) the set of seed malicious domains or seed malicious IP addresses to identify those domains or IP addresses that the system/service is to use to perform a guided domain discovery. For example, the system may have constrained resources (e.g., time, compute resources, etc.) to use all domains or IP addresses to explore the sub-graphs or discover new domains. Accordingly, the system filters the seed list to identify a set of domains or IP addresses that are expected to result in a more effective domain discovery. The system can filter the seed list based on predicted maliciousness scores for at least a subset of domains or IP addresses comprised in the seed list.

At 1105, the system obtains an indication to perform a guided domain crawling to identify likely malicious domains. The system can determine to perform a guided domain crawling of network neighborhoods associated with seed malicious domains or malicious IP addresses to identify suspicious domains. For example, the system determines to proactively discover suspicious domains that can be classified (e.g., by querying a classifier that predicts a maliciousness of a domain) to identify malicious domains before the domains are identified through intercepted network traffic (e.g., traffic intercepted by an inline firewall, etc.).

At 1110, the system obtains a set of seed list of malicious domains and IP addresses. The seed list of malicious domains and IP addresses may be determined based at least in part on malicious domain streams. The malicious domain streams may be received from one or more sources (e.g., third party services or other systems) and may comprise indications of known malicious domains or known malicious IP addresses. The system can determine which of the known malicious domains or known malicious IP addresses to use as a seed resource (e.g., a seed domain or a seed IP address) based on performing a classification of the domain or IP address, for example, by querying a classifier to provide a predicted maliciousness classification (e.g., a maliciousness score).

At 1115, the system selects a malicious domain or IP address from the set of seed list. The system can select the malicious domain or malicious IP address according to a priority that is determined based at least in part on classifications for the domains or IP addresses (e.g., the maliciousness scores associated with the malicious domain or malicious IP address). For example, the system selects the malicious domain or IP address in order to first analyze those domains or IP addresses that have a greater likelihood of being maliciousness or otherwise an indication that the domain or IP address comprises more characteristics that lead to the classification of the domain or IP address as being malicious.

At 1120, the system determines one or more characteristics pertaining to the selected domain or IP address. For example, the system extracts one or more features or embeddings from information pertaining to the selected domain or IP address. The system can generate a feature vector to be used in connection with querying a classifier for a predicted classification for the selected domain or IP address.

At 1125, the system queries a classifier for a set of predicted maliciousness classifications for the selected malicious domain or IP address. The classifier may be a machine learning model, such as a lightweight machine learning model.

At 1130, the system obtains a predicted maliciousness score from the classifier.

At 1135, the system determines whether the predicted maliciousness score is greater than a predefined maliciousness score threshold. In response to determining that the predicted maliciousness score is not greater than a predefined maliciousness score threshold, process 1100 proceeds to 1145. Conversely, in response to determining that the predicted maliciousness score is greater than a predefined maliciousness score threshold, process 1100 proceeds to 1140 at which the system stores an indication that the selected domain or IP address is a likely malicious domain.

At 1145, the system determines whether more domains or IP addresses are to be evaluated. For example, the system determines whether the seed list of malicious domains or malicious IP addresses comprises more domains or IP addresses to be evaluated or whether the allocated time or compute resources allocated for evaluating the seed list have capacity to evaluate additional domains or IP addresses. In response to determining that more domains or IP addresses (e.g., from the seed list) are to be evaluated, process 1100 returns to 1115 at which process 1100 iterates over 1115-1145 until no further domains or IP addresses are to be evaluated. Conversely, in response to determining that no further domains or IP addresses are to be evaluated, process 1100 proceeds to 1150.

At 1150, the system provides an indication of the likely malicious domains or IP addresses (or likely malicious resources). In some embodiments, the system provides the indication to another process, service, or system that invoked process 1100.

At 1155, a determination is made as to whether process 1100 is complete. In some embodiments, process 1100 is determined to be complete in response to a determination that no further seed domains or seed IP addresses are to be evaluated, a predefined time period for performing the guided domain crawling has elapsed, an administrator indicates that process 1100 is to be paused or stopped, etc. In response to a determination that process 1100 is complete, process 1100 ends. In response to a determination that process 1100 is not complete, process 1100 returns to 1105.

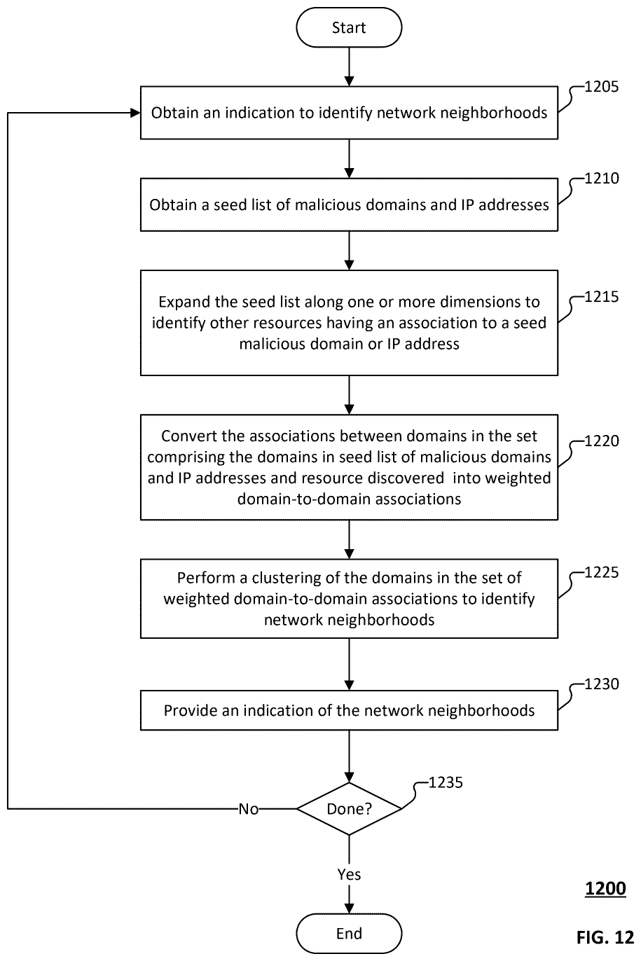

FIG. 12 is a flow diagram of a method for determining a set of network neighborhoods according to various embodiments. In some embodiments, process 1200 is implemented at least in part by system 100 of FIG. 1 and/or system 200 of FIG. 2. Process 1200 may be implemented by an upstream device such as a worker node, a virtual machine, etc.

At 1205, the system obtains an indication to identify network neighborhoods. In some embodiments, the system determines to identify network neighborhoods in connection with the periodic guided domain crawling/discovery or otherwise requested guided domain crawling/discovery. For example, the guided domain crawling is performed according to a predefined schedule such as daily, weekly, monthly, etc. Additionally, or alternatively, the guided domain crawling is performed upon request from an administrator or other user. Another system or process can determine to perform the guided domain crawling and provide an indication to process 1200, or otherwise invoke process 1200.

At 1210, the system obtains a seed list of malicious domains and IP addresses. At 1215, the system expands the seed list along one or more dimensions to identify other resources having an association to a seed malicious domain or IP address. The system can expand the seed list along one or more dimensions in a same or similar manner to the resource expansion described in connection with process 1000.

At 1220, the system converts the associations between domains in the set comprising the domains in the seed list of malicious domains and IP addresses and discovered resources into weighted-to-domain associations. As an illustrative example, a first domain discovered via expanding a sub-graph for a particular seed domain may have (a) the same hosting IP address, (b) the same set of hyperlinks, and (c) the same registration record. Accordingly, the system may collapse the relationships between the first domain and the particular seed domain to a domain-to-domain relationship having a weighting of 3 (e.g., the weighting being determined based on a number of network infrastructure resources that are shared between the domain, or otherwise a number of connections/relationships between the domains). As another illustrative example, a second domain discovered via expanding the sub-graph for the particular seed domain may have a same set of squatting keywords. The association between the second domain and the particular seed domain is collapsed to a domain-to-domain relationship having a weighting of 1.

At 1225, the system performs a clustering of the domains in the set of weighted domain-to-domain associations to identify network neighborhoods. For example, the system uses the clustering to identify strongly connected/related neighborhoods of domains. The clustering technique may include implementing a community detection algorithm. Examples of clustering techniques include Louvain, Walktrap and Leiden, etc.

At 1230, the system provides an indication of the network neighborhoods.

At 1235, a determination is made as to whether process 1200 is complete. In some embodiments, process 1200 is determined to be complete in response to a determination that no further network neighborhoods are to be identified, no further domains or IP addresses from a seed list are to be explored/expanded, an administrator indicates that process 1200 is to be paused or stopped, etc. In response to a determination that process 1200 is complete, process 1200 ends. In response to a determination that process 1200 is not complete, process 1200 returns to 1205.

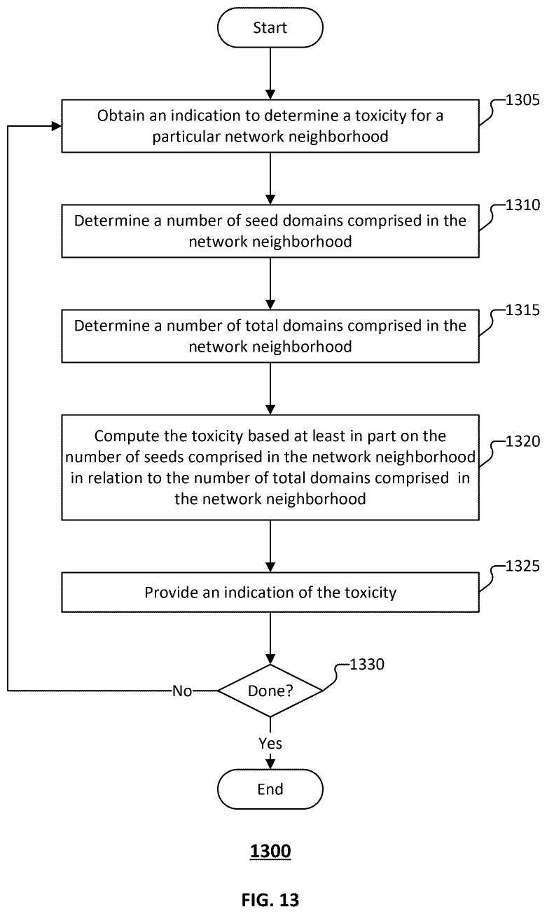

FIG. 13 is a flow diagram of a method for determining a toxicity for a network neighborhood according to various embodiments. In some embodiments, process 1300 is implemented at least in part by system 100 of FIG. 1 and/or system 200 of FIG. 2. Process 1300 may be implemented by an upstream device such as a worker node, a virtual machine, etc.

At 1305, the system obtains an indication to determine a toxicity for a particular network neighborhood. At 1310, the system determines a number of seed domains comprised in the network neighborhood. At 1315, the system determines a number of total domains comprised in the network neighborhood. At 1320, the system computes the toxicity based at least in part on the number of seeds comprised in the network neighborhood in relation to the number of total domains comprised in the network neighborhood. At 1325, the system provides an indication of the toxicity. In some embodiments, the system provides the indication to another process, service, or system that invoked process 1300. At 1330, a determination is made as to whether process 1300 is complete. In some embodiments, process 1300 is determined to be complete in response to a determination that no further network neighborhoods are to be evaluated, an administrator indicates that process 1300 is to be paused or stopped, etc. In response to a determination that process 1300 is complete, process 1300 ends. In response to a determination that process 1300 is not complete, process 1300 returns to 1305.

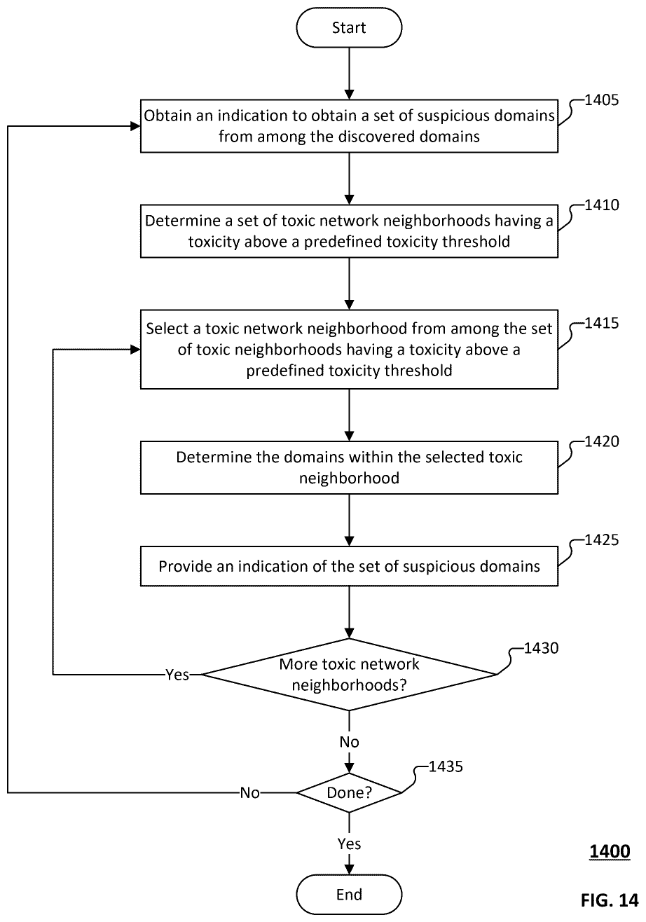

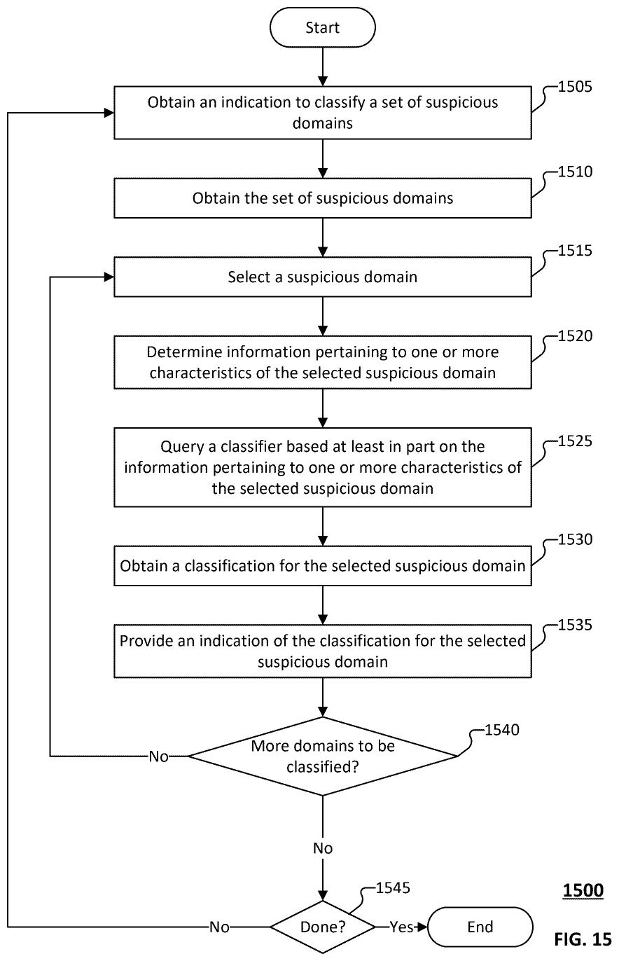

FIG. 14 is a flow diagram of a method for identifying a set of suspicious domains according to various embodiments. In some embodiments, process 1400 is implemented at least in part by system 100 of FIG. 1 and/or system 200 of FIG. 2. Process 1400 may be implemented by an upstream device such as a worker node, a virtual machine, etc.

At 1405, the system obtains an indication to obtain a set of suspicious domains from among the discovered domains. At 1410, the system determines a set of toxic network neighborhoods having a toxicity above a predefined toxicity threshold. At 1415, the system selects a toxic network neighborhood from among the set of toxic neighborhoods having a toxicity above a predefined toxicity threshold. At 1420, the system determines the domains within the selected toxic neighborhood. In some embodiments, the system determines the newly discovered domains within the selected toxic neighborhood, such as by excluding those seed domains or IP address within the selected toxic neighborhood (e.g., because the seed domain or seed IP address are not a suspicious domains—they are known malicious domains/IP addresses). At 1425, the system provides an indication of the set of suspicious domains. In some embodiments, the system provides the indication to another process, service, or system that invoked process 1400. At 1430, the system determines whether additional toxic network neighborhoods are to be evaluated. For example, the system determines whether another toxic network neighborhoods is to be evaluated (e.g., that the set of toxic network neighborhoods comprises one or more toxic network neighborhoods that have not yet been evaluated), such as to identify domains within the toxic network neighborhood. In response to determining that another toxic network neighborhood is to be evaluated, process 1400 returns to 1415 and process 1400 iterates over 1415-1430 until no further toxic network neighborhoods are to be evaluated (e.g., no further domains are to be discovered within toxic network neighborhoods). Conversely, in response to determining that no further toxic network neighborhoods are to be evaluated, process 1400 proceeds to 1435. At 1435, a determination is made as to whether process 1400 is complete. In some embodiments, process 1400 is determined to be complete in response to a determination that no further toxic network neighborhoods are to be evaluated, no further domains are to be explored or discovered, a predefined time period allocated for domain discovery, an administrator indicates that process 1400 is to be paused or stopped, etc. In response to a determination that process 1400 is complete, process 1400 ends. In response to a determination that process 1400 is not complete, process 1400 returns to 1405.

FIG. 15 is a flow diagram of a method for classifying a candidate domain according to various embodiments. In some embodiments, process 1500 is implemented at least in part by system 100 of FIG. 1 and/or system 200 of FIG. 2. Process 1500 may be implemented by an upstream device such as a worker node, a virtual machine, etc.

At 1505, the system obtains an indication to classify a set of suspicious domains. At 1510, the system obtains the set of suspicious domains. At 1515, the system selects a suspicious domain. At 1520, the system determines information pertaining to one or more characteristics of the selected suspicious domain. For example, the system determines one or more features or embeddings for the selected suspicious domain. At 1525, the system queries a classifier based at least in part on the information pertaining to one or more characteristics of the selected suspicious domain. The classifier may be a machine learning model. In some embodiments, the classifier predicts whether a domain is malicious or a likelihood that a domain is malicious, etc. At 1530, the system obtains a classification for the selected suspicious domain. At 1535, the system provides an indication of the classification for the selected suspicious domain. In some embodiments, the system provides the indication to another process, service, or system that invoked process 1500. In some embodiments, the indication is provided to a system or service that manages whitelists of benign domains and/or blacklists of malicious domains, or security policies that instruct firewalls how traffic to/from certain domains is to be handled. At 1540, the system determines whether another domain(s) is to be classified. In response to determining that another domain is to be classified, process 1500 returns to 1515 and process 1500 iterates over 1515-1540 until no further domains are to be classified. Conversely, in response to determining that no further domains are to be classified, process 1500 proceeds to 1545.

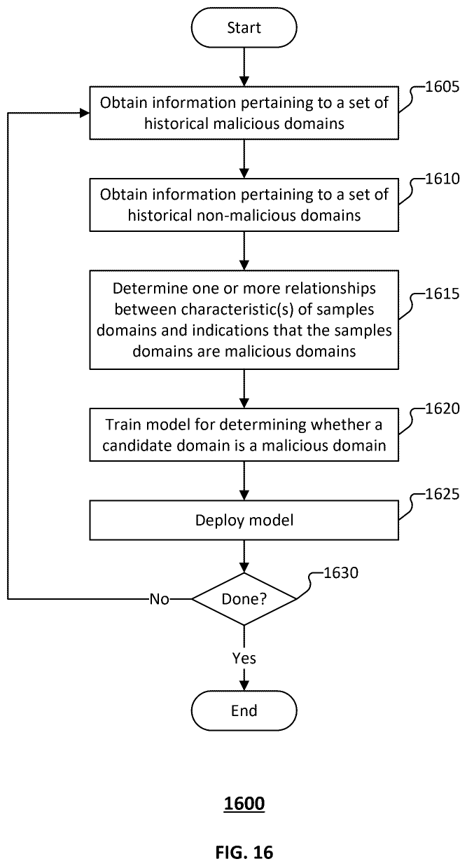

FIG. 16 is a flow diagram of a method for training a model according to various embodiments. In some embodiments, process 1600 is implemented at least in part by system 100 of FIG. 1 and/or system 200 of FIG. 2.

Although the example shown is described in the context of training a model to classify domains (e.g., to predict whether the domain is malicious), the same or similar process can be implemented for the training a model to classify IP addresses. Additionally, similar processes may be implemented to train other machine learning models disclosed herein, such as a model to predict a maliciousness of a domain, etc.

At 1605, information pertaining to a set of historical malicious domains is obtained. In some embodiments, the system obtains the information pertaining to a set of historical known malicious domains known internally or from a third-party service (e.g., VirusTotal™, threat feeds, etc.). At 1610, information pertaining to a set of historical known non-malicious domains (e.g., benign domains) is obtained. The information pertaining to the set of non-malicious domains may be obtained internally or from a third-party service (e.g., VirusTotal™). At 1615, one or more relationships between characteristic(s) of domains and indications that the candidate domains are malicious domains. For example, the system determines a set of features to be used by a classifier (e.g., a machine learning model) to classify candidate domains. At 1620, a model for determining whether a domain is a malicious domain is trained. The model may be a machine learning model. For example, the model is trained using a machine learning process. Examples of machine learning processes that can be implemented in connection with training the model include random forest, linear regression, support vector machine, naive Bayes, logistic regression, K-nearest neighbors, decision trees, gradient boosted decision trees, etc. At 1625, the model is deployed. In some embodiments, the deploying of the model includes storing the model in a dataset of models for use in connection with analyzing traffic to determine whether the traffic is to/from a DNS hijacked or otherwise malicious domain. Deploying the model can include providing the model (or a location at which the model can be invoked) to a malicious traffic detector, such as domain classifier comprised in security platform 140 of system 100 of FIG. 1. At 1630, a determination is made as to whether process 1600 is complete. In some embodiments, process 1600 is determined to be complete in response to a determination that no further models are to be determined/trained (e.g., no further classification models are to be created), an administrator indicates that process 1600 is to be paused or stopped, etc. In response to a determination that process 1600 is complete, process 1600 ends. In response to a determination that process 1600 is not complete, process 1600 returns to 1605.

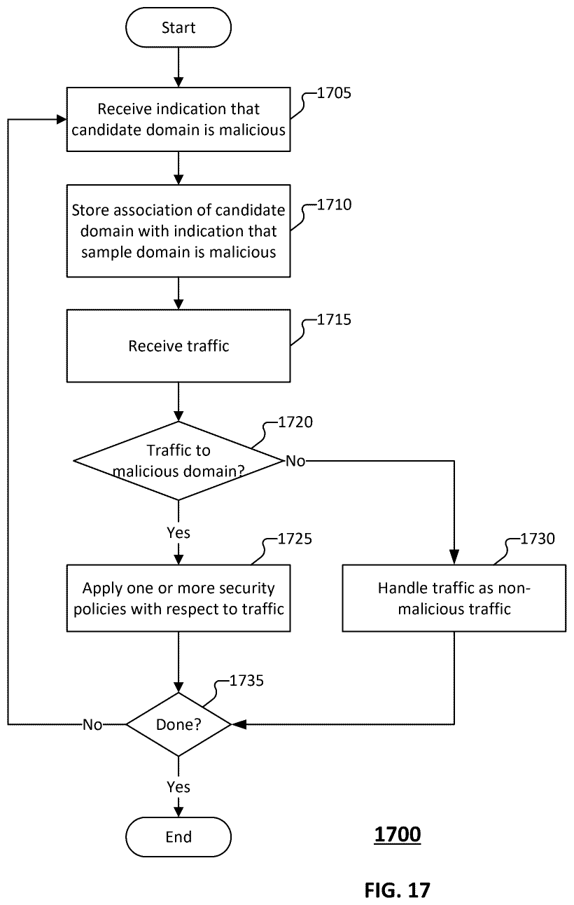

FIG. 17 is a flow diagram of a method for detecting malicious traffic according to various embodiments. In some embodiments, process 1700 is implemented at least in part by system 100 of FIG. 1 and/or system 200 of FIG. 2. Process 1700 may be implemented by an inline security entity.

In some implementations, process 1700 may be implemented by a client device such as a laptop, a smartphone, a personal computer, etc., such as in connection with executing or opening a file such as an email attachment.

At 1705, an indication that the candidate domain is malicious is received. In some embodiments, the system receives an indication that a candidate domain is malicious, and the domain or hash, signature, or other unique identifier associated with the domain. For example, the system may receive the indication that the domain is malicious from a service such as a security or malware service (e.g., security platform 140 of FIG. 1). The service implements an offline classification of domains, and can maintain a whitelist or blacklist of domains for inline handling. The system may receive the indication that the domain is malicious from one or more servers.

According to various embodiments, the indication that the candidate domain is a malicious domain is received in connection with an update to a set of previously identified malicious domains. For example, the system receives the indication that the candidate domain is malicious as an update to a blacklist of malicious domains.

At 1710, an association of the candidate domain with an indication that the domain is otherwise malicious is stored. In response to receiving the indication that the domain is malicious, the system stores the indication that the domain is malicious in association with the domain or an identifier corresponding to the domain to facilitate a lookup (e.g., a local lookup) of whether subsequently received traffic is to/from malicious domains. In some embodiments, the identifier corresponding to the domain stored in association with the indication that the domain is malicious comprises a hash of the domain, a signature of the domain, or another unique identifier associated with the domain.

At 1715, traffic is received. The system may obtain traffic such as in connection with routing traffic within/across a network, or mediating traffic into/out of a network such as a firewall, or a monitoring of email traffic or instant message traffic. The traffic may be obtained based on the inline security entity monitoring application traffic or network traffic.

At 1720, a determination of whether the traffic is to a malicious domain is performed. In some embodiments, the system obtains a candidate domain from the received traffic. In response to obtaining the candidate domain from the traffic, the system determines whether the candidate domain corresponds to a malicious domain such as by performing a lookup against a blacklist of malicious domains. In response to determining that the candidate domain is comprised in the set of domains on the blacklist of malicious domains, the system determines that the domain is a malicious domain.

In some embodiments, the system determines whether the candidate domain corresponds to a domain comprised in a set of previously identified benign domains such as a whitelist of benign domains. In response to determining that the candidate domain is comprised in the set of domains on the whitelist of benign domains, the system determines that the domain is not malicious.

According to various embodiments, in response to determining the candidate domain is not comprised in a set of previously identified malicious domains (e.g., a blacklist of malicious domains) or a set of previously identified benign domains (e.g., a whitelist of benign domains), the system deems the domain as being non-malicious (e.g., benign).

According to various embodiments, in response to determining the candidate domain is not comprised in a set of previously identified malicious domains (e.g., a blacklist of malicious domains) or a set of previously identified benign domains (e.g., a whitelist of benign domains), the system queries a malicious domain detector (e.g., a classifier or a security service, such as security platform 140 of FIG. 1) to determine whether the candidate domain is a malicious domain. For example, the system may quarantine traffic to/from the domain until the system receives response from the malicious domain detector as to whether the domain is (e.g., predicted to be) malicious. The malicious domain detector may perform an assessment of whether the candidate domain is malicious such as contemporaneous with the handling of the traffic by the system (e.g., in real-time with the query from the system). The malicious domain detector may correspond to domain classifier comprised in security platform 140 of system 100 of FIG. 1.

In some embodiments, the system determines whether the candidate domain is comprised in the set of previously identified malicious domains or the set of previously identified benign domains by computing a hash or determining a signature or other unique identifier associated with the domain and performing a lookup in the set of previously identified malicious domains or the set of previously identified benign domains for a domain matching the hash, signature or other unique identifier. Various hashing techniques may be implemented.

In response to a determination that the traffic does not correspond to traffic to/from a malicious domain at 1720, process 1700 proceeds to 1730 at which traffic to/from the domain is handled as non-malicious traffic/information.

Conversely, in response to a determination that the traffic corresponds to traffic to/from a DNS hijacked domain or malicious domain at 1720, process 1700 proceeds to 1725 at which traffic to/from the domain is handled as malicious traffic/information. The system may handle the malicious traffic/information based at least in part on one or more policies such as one or more security policies.

According to various embodiments, the handling of the malicious traffic/information (e.g., traffic to/from a malicious domain) may include performing an active measure. The active measure may be performed in accordance with (e.g., based at least in part on) one or more security policies. As an example, the one or more security policies may be preset by a network administrator, a customer (e.g., an organization/company) to a service that provides detection of malicious domains, etc. Examples of active measures that may be performed include: isolating the traffic to/from the malicious domain (e.g., quarantining the traffic), deleting the traffic, prompting the user to alert the user that a malicious domain was detected, providing a prompt to a user when the a device attempts to open access the domain, blocking transmission of information to/from the domain, updating a blacklist of malicious domains (e.g., a mapping of a hash for the domain to an indication that the candidate domain is malicious, etc.

At 1735, a determination is made as to whether process 1700 is complete. In some embodiments, process 1700 is determined to be complete in response to a determination that no further domains are to be analyzed (e.g., no further predictions for domains are needed), an administrator indicates that process 1700 is to be paused or stopped, etc. In response to a determination that process 1700 is complete, process 1700 ends. In response to a determination that process 1700 is not complete, process 1700 returns to 1705.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

1. A system, comprising:
one or more processors configured to:
determine a set of seed malicious domains;
expand one or more network graphs for the set of seed malicious domains to obtain a set of network neighborhoods;
determine a set of domains expected to be malicious from a set of toxic network neighborhoods, wherein the set of toxic network neighborhoods are determined based at least part on the set of network neighborhoods, and a particular toxic network neighborhood shares a plurality of hosting environments; and
perform an action based at least in part on the set of domains expected to be malicious; and
a memory coupled to the one or more processors and configured to provide the one or more processors with instructions.

2. The system of claim 1, wherein a domain is deemed to be a seed domain in response to determining that a likelihood that the domain is malicious exceeds a predefined maliciousness threshold.

3. The system of claim 1, wherein performing the action comprises performing a maliciousness classification for the set of domains expected be malicious.

4. The system of claim 1, wherein performing the action comprises performing a crawling of the set of domains based at least in part on using a guided domain crawler.

5. The system of claim 1, wherein performing the action comprises prioritizing a classifying of the set of domains expected to be malicious over domains comprised in a non-toxic network neighborhood.

6. The system of claim 1, wherein the plurality of hosting environments comprise two or more of (a) a hosting IP address, (b) a TLS certificate, (c) an implemented phishing kit, (d) a registration record, (e) a CNAME record, (f) one or more hyperlinks comprised in a website, (g) malware files hosted at a domain, (h) a redirection chain, (i) a set of keywords, (j) a tracking identifier, and (k) a logo hosted comprised in the website.

7. The system of claim 1, wherein determining the set of toxic network neighborhoods comprises identifying a set of network neighborhoods based at least in part on a set of associations among domains within the set of network neighborhoods.

8. The system of claim 1, wherein the one or more processors are further configured to:
obtain a stream of malicious domains from one or more domain classification sources; and
determine a set of recently observed malicious domains within the stream of malicious domains.

9. The system of claim 8, wherein a recently observed malicious domain corresponds to a domain for which network traffic was intercepted within a most recent predefined number of days.

10. The system of claim 8, wherein the one or more processors are further configured to:
obtain a stream of malicious IP addresses from one or more IP classification sources; and
determine a set of recently observed malicious IP addresses within the stream of malicious IP addresses.

11. The system of claim 10, wherein:
the one or more processors are further configured to:
query one or more machine learning models for a predicted maliciousness classification based at least in part on one or more of the set of recently observed malicious domains and the set of recently observed IP addresses; and
the set of seed domains is determined based at least in part on identifying domains having an associated predicted maliciousness classification that satisfies a maliciousness criteria.

12. The system of claim 11, wherein the maliciousness criteria is one of: (a) a domain is within a top N most malicious domains where N is a predefined positive integer, and (b) a domain has an associated predicted maliciousness classification that exceeds a predefined maliciousness threshold.

13. The system of claim 11, wherein the set of seed domains are used for a guided crawling of domains to identify a set of domains observed within an immediately preceding N days, where N is a predefined positive integer.

14. The system of claim 11, wherein the set of network neighborhoods is determined based at least in part on the set of seed domains.

15. The system of claim 14, wherein determining the set of domains expected to be malicious from the set of toxic network neighborhoods comprises:
performing a clustering with respect to the one or more expanded network graphs to identify a set of network neighborhoods;
determining a toxicity level for each of the set of network neighborhoods; and
determining the set of toxic network neighborhoods based at least in part on determining a subset of the set of network neighborhoods having a corresponding toxicity level above a predefined toxicity threshold.

16. The system of claim 15, wherein determining the set of domains expected to be malicious from the set of toxic network neighborhoods comprises:
identifying domains within a set of clusters associated with the set of toxic network neighborhoods.

17. The system of claim 15, wherein the toxicity of a network neighborhood is determined based at least in part on a number of seed domains in relation to a total number of domains within a graph for the network neighborhood.

18. A method, comprising:
determining a set of toxic network neighborhoods on the internet, wherein a particular toxic network neighborhood shares a plurality of hosting environments;
expanding one or more network graphs for the set of toxic network neighborhoods;
determining a set of domains expected to be malicious from the set of toxic network neighborhoods; and
performing an action based at least in part on the set of domains expected to be malicious.

19. A computer program product embodied in a non-transitory computer readable medium and comprising computer instructions for:
determining a set of toxic network neighborhoods on the internet, wherein a particular toxic network neighborhood shares a plurality of hosting environments;
expanding one or more network graphs for the set of toxic network neighborhoods;
determining a set of domains expected to be malicious from the set of toxic network neighborhoods; and
performing an action based at least in part on the set of domains expected to be malicious.

20. A system, comprising:
one or more processors configured to:
identify a toxic community of domains;
determine a sub-graph of domains within the toxic community based at least in part on a determination that a toxicity of the sub-graph exceeds a toxicity threshold;
prioritize classifying domains comprised in the sub-graph over domains within another sub-graph having a lower corresponding toxicity; and
perform a prioritized crawling using a guided domain crawler on the sub-graph of domains; and
a memory coupled to the one or more processors and configured to provide the one or more processors with instructions.

21. The system of claim 20, wherein the toxicity of the sub-graph is determined based at least in part on a number of known malicious domains in relation to a total number of domains within the sub-graph.
